(19) United States
(12) Patent Application Publication
(10) Pub. No.: US 2016/0378106 A1
(43) Pub. Date: Dec. 29, 2016

(54) METHOD AND DEVICE FOR MANAGING A SELF-BALANCING VEHICLE

(71) Applicant: Xiaomi Inc., Beijing (CN)

(72) Inventors: Yan XIE, Beijing (CN); Tian REN, Beijing (CN); Yueyue CHU, Beijing (CN)

(73) Assignee: Xiaomi Inc., Beijing (CN)

(21) Appl. No.: 15/182,867

(22) Filed: Jun. 15, 2016

(30) Foreign Application Priority Data
Jun. 26, 2015 (CN) 201510369380.0

(51) Int. Cl. G05D 1/00; B62K 3/00; H04W 4/00; G01C 21/36; H04W 76/02; G06F 17/18; G07C 5/06

(52) U.S. Cl. CPC G05D 1/0016; G06F 17/18; B62K 3/007; G07C 5/06; G05D 1/0038; G05D 1/0022; G05D 1/0055; G01C 21/3667; H04W 76/02; H04W 4/008

(57) ABSTRACT

The present disclosure relates to a method and a device for managing a self-balancing vehicle. The method may include: establishing a connection with the self-balancing vehicle through Bluetooth; acquiring status information of the self-balancing vehicle through the connection; and managing the self-balancing vehicle according to the status information of the self-balancing vehicle. Thereby, through the present disclosure, the user terminal may manage the navigation state of the self-balancing vehicle through Bluetooth connection. Thus, it not only improves the management efficiency of the self-balancing vehicle, but also brings convenience for the user to manage the self-balancing vehicle, and improves the user experience.

### PRIORITY STATEMENT

The present application is based upon and claims priority to Chinese Patent Application No. 201510369380.0, filed Jun. 26, 2015, the entire contents of which are incorporated herein by reference.

### TECHNICAL FIELD

The present disclosure generally relates to the field of network communication technology, and more particularly, to a method and a device for managing a self-balancing vehicle.

### BACKGROUND

In the related art, a self-balancing vehicle can detect changes in its posture by a built-in gyroscope and acceleration sensor and can adjust a driving motor accordingly by a servo management system to keep balance of a system.

### SUMMARY

In order to better manage operations of a self-balancing vehicle and solve other technical problems in the related art, the present disclosure may provide a method and a device for managing a self-balancing vehicle.

According to an aspect of embodiments of the present disclosure, a method for a mobile terminal to manage a self-balancing vehicle may include establishing a connection with the self-balancing vehicle through Bluetooth™ connection; acquiring status information of the self-balancing vehicle through the connection; and managing the self-balancing vehicle according to the status information of the self-balancing vehicle.

According to another aspect of embodiments of the present disclosure, a mobile terminal device may include a non-transitory storage medium including a set of instructions for managing a self-balancing vehicle, and a processor in communication with the storage medium. When executing the set of instructions, the processor is directed establish a connection with the self-balancing vehicle through Bluetooth™; acquire status information of the self-balancing vehicle through the connection; and manage the self-balancing vehicle according to the status information of the self-balancing vehicle.

The technical scheme according to embodiments of the present disclosure may have the following beneficial effects.

In the present disclosure, the user terminal establishes a connection with the self-balancing vehicle through Bluetooth; acquires status information of the self-balancing vehicle through the Bluetooth connection; and manages the self-balancing vehicle according to the status information of the self-balancing vehicle. Thereby, the user terminal may manage the navigation state of the self-balancing vehicle through Bluetooth connection. Thus, it not only improves the management efficiency of the self-balancing vehicle, but also brings convenience for the user to manage the self-balancing vehicle, and improves the user experience.

In the present disclosure, the user terminal may support to adjust speed of the self-balancing vehicle, send the speed adjusting value of the user to the self-balancing vehicle through the Bluetooth connection, which satisfies the speed adjusting the need of the user with respect to the self-balancing vehicle, and improves the user experience.

In the present disclosure, the user terminal may search for the self-balancing vehicle through Bluetooth, and establish the Bluetooth connection with the self-balancing vehicle. In particular, the user terminal may establish a connection with the self-balancing vehicle selected by the user, which saves time for the user to search for the self-balancing vehicle and improves the efficiency of searching for the self-balancing vehicle by the user.

In the present disclosure, when the user terminal manages the self-balancing vehicle, the status information of the self-balancing vehicle needs to be acquired. The status information of the self-balancing vehicle may be acquired by a passive receiving way or an active acquiring way, thus improving the efficiency of acquiring the status information of the self-balancing vehicle by the user terminal.

In the present disclosure, the user terminal displays the status information of the self-balancing vehicle in the management interface, and detects the status information. When any information among the status information reaches corresponding navigation state threshold, it is alarmed. Therefore, the user may take corresponding safety measures for the self-balancing vehicle according to different alarms of the user terminal, which may improve the safety for the user to use the self-balancing vehicle and improve the user experience.

In the present disclosure, when the self-balancing vehicle is in a locked state, the user terminal may also acquire a remaining battery power and a remaining cursing mileage of the self-balancing vehicle, and display the remaining battery power and remaining cursing mileage of the self-balancing vehicle on a lock screen interface. Therefore, the user may determine whether to charge the self-balancing vehicle according to the remaining battery power and remaining cursing mileage of the self-balancing vehicle on the lock screen interface. Thus, it improves the user experience and also increases the safety to use the self-balancing vehicle.

In the present disclosure, the user terminal may support the user to set light colors, and send a color adjustment instruction containing the selected light color value to the self-balancing vehicle through the Bluetooth connection. Therefore, it satisfies the need of the user to set the light colors, improving the user experience.

In the present disclosure, the use terminal may support the user to set a navigation direction, and specific setting ways are provided in the management interface. Therefore, the user may accomplish setting the navigation way of the self-balancing vehicle by operating the management interface, which may reduce difficulty for the user to set the navigation direction and improve the user experience.

In the present disclosure, the user terminal may support a camera mode, such that the user may also acquire the ambient environmental condition and photograph while he is managing the self-balancing vehicle. Thus, different needs of the user may be better satisfied, and the safety for the user to use the self-balancing vehicle is also improved.

In the present disclosure, the management interface of the user terminal supports vehicle searching function. It may not only acquire a vehicle searching warning but also acquire a distance from the self-balancing vehicle, which better satisfies the need of the user and improves the user experience.

In the present disclosure, the user terminal may support function of remotely controlling the self-balancing vehicle, send input information of a navigation direction and navigation speed of the user to the self-balancing vehicle to remotely control travelling of the self-balancing vehicle. Thus, the need of the user to remotely control the self-balancing vehicle is satisfied and the user experience is improved.

In the present disclosure, the user terminal may support guiding function, and may feedback the guiding information to the user according to the need of guiding in real time, such that the user may acquire the guiding information timely. Thus, it may avoid the user getting lost, improve the safety for the user to use the self-balancing vehicle and improve the user experience.

In the present disclosure, the user terminal may support compass function. A direction indicated by the compass of a system may be displayed in the management interface in real time, such that the user may acquire the guiding information timely. Thus, it may avoid the user getting lost, improve the safety for the user to use the self-balancing vehicle and improve the user experience.

In the present disclosure, the user terminal may support remote upgrade function of the self-balancing vehicle, and send an upgrading instruction to the self-balancing vehicle through the Bluetooth connection, such that the self-balancing vehicle upgrades according to the upgrading instruction and returns an upgrading result to the user terminal, thus increasing management scope of the self-balancing vehicle, improving management efficiency of the self-balancing vehicle, and also improving the safety for the user to use the self-balancing vehicle.

In the present disclosure, the user terminal may support user interaction function, and establish a connection with a server to send or receive interacting information. Various needs of the user are satisfied and the user experience is improved.

In the present disclosure, the user terminal may acquire and display a statistical result of the self-balancing vehicle of the server, to facilitate the user to better manage the self-balancing vehicle according to the statistical result. Thus, the user may manage the self-balancing vehicle more safely and more efficiently and improve the user experience.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart illustrating a method for managing a self-balancing vehicle according to an exemplary embodiment of the present disclosure;

FIG. 2 is a flowchart illustrating a method for managing a self-balancing vehicle according to another exemplary embodiment of the present disclosure;

FIG. 3 is a flowchart illustrating a method for managing a self-balancing vehicle according to another exemplary embodiment of the present disclosure;

FIG. 4 is a flowchart illustrating a method for managing a self-balancing vehicle according to another exemplary embodiment of the present disclosure;

FIG. 5 is a flowchart illustrating a method for managing a self-balancing vehicle according to another exemplary embodiment of the present disclosure;

FIG. 6 is a flowchart illustrating a method for managing a self-balancing vehicle according to another exemplary embodiment of the present disclosure;

FIG. 7 is a flowchart illustrating a method for managing a self-balancing vehicle according to another exemplary embodiment of the present disclosure;

FIG. 8 is a flowchart illustrating a method for managing a self-balancing vehicle according to another exemplary embodiment of the present disclosure;

FIG. 9 is a flowchart illustrating a method for managing a self-balancing vehicle according to another exemplary embodiment of the present disclosure;

FIG. 10 is a flowchart illustrating a method for managing a self-balancing vehicle according to another exemplary embodiment of the present disclosure;

FIG. 11 is a flowchart illustrating a method for managing a self-balancing vehicle according to another exemplary embodiment of the present disclosure;

FIG. 12 is a flowchart illustrating a method for managing a self-balancing vehicle according to another exemplary embodiment of the present disclosure;

FIG. 13 is a flowchart illustrating a method for managing a self-balancing vehicle according to another exemplary embodiment of the present disclosure;

FIG. 14 is a flowchart illustrating a method for managing a self-balancing vehicle according to another exemplary embodiment of the present disclosure;

FIG. 15 is a flowchart illustrating a method for managing a self-balancing vehicle according to another exemplary embodiment of the present disclosure;

FIG. 16 is a flowchart illustrating a method for managing a self-balancing vehicle according to another exemplary embodiment of the present disclosure;

FIG. 17 is a diagram illustrating an application scenario of a method for managing a self-balancing vehicle according to an exemplary embodiment of the present disclosure;

FIG. 18 is a display schematic diagram of a management interface of a user terminal according to an exemplary embodiment of the present disclosure;

FIG. 19 is a display schematic diagram of a management interface of a user terminal according to another exemplary embodiment of the present disclosure;

FIG. 20 is a display schematic diagram of a management interface of a user terminal according to another exemplary embodiment of the present disclosure;

FIG. 21 is a block diagram of a device for managing a self-balancing vehicle according to an exemplary embodiment of the present disclosure;

FIG. 22 is a block diagram of a device for managing a self-balancing vehicle according to another exemplary embodiment of the present disclosure;

FIG. 23 is a block diagram of a device for managing a self-balancing vehicle according to another exemplary embodiment of the present disclosure;

FIG. 24 is a block diagram of a device for managing a self-balancing vehicle according to another exemplary embodiment of the present disclosure;

FIG. 25 is a block diagram of a device for managing a self-balancing vehicle according to another exemplary embodiment of the present disclosure;

FIG. 26 is a block diagram of a device for managing a self-balancing vehicle according to another exemplary embodiment of the present disclosure;

FIG. 27 is a block diagram of a device for managing a self-balancing vehicle according to another exemplary embodiment of the present disclosure;

FIG. 28 is a block diagram of a device for managing a self-balancing vehicle according to another exemplary embodiment of the present disclosure;

FIG. 29 is a block diagram of a device for managing a self-balancing vehicle according to another exemplary embodiment of the present disclosure;

FIG. 30 is a block diagram of a device for managing a self-balancing vehicle according to another exemplary embodiment of the present disclosure;

FIG. 31 is a block diagram of a device for managing a self-balancing vehicle according to another exemplary embodiment of the present disclosure;

FIG. 32 is a block diagram of a device for managing a self-balancing vehicle according to another exemplary embodiment of the present disclosure;

FIG. 33 is a block diagram of a device for managing a self-balancing vehicle according to another exemplary embodiment of the present disclosure;

FIG. 34 is a block diagram of a device for managing a self-balancing vehicle according to another exemplary embodiment of the present disclosure;

FIG. 35 is a block diagram of a device for managing a self-balancing vehicle according to another exemplary embodiment of the present disclosure;

FIG. 36 is a block diagram of a device for managing a self-balancing vehicle according to another exemplary embodiment of the present disclosure;

FIG. 37 is a block diagram of a device for managing a self-balancing vehicle according to another exemplary embodiment of the present disclosure;

FIG. 38 is a block diagram of a device for managing a self-balancing vehicle according to another exemplary embodiment of the present disclosure;

FIG. 39 is a block diagram of a device for managing a self-balancing vehicle according to another exemplary embodiment of the present disclosure;

FIG. 40 is a block diagram of a device for managing a self-balancing vehicle according to another exemplary embodiment of the present disclosure;

FIG. 41 is a block diagram of a device for managing a self-balancing vehicle according to another exemplary embodiment of the present disclosure;

FIG. 42 is a block diagram of a device for managing a self-balancing vehicle according to another exemplary embodiment of the present disclosure;

FIG. 43 is a block diagram of a device for managing a self-balancing vehicle according to another exemplary embodiment of the present disclosure;

FIG. 44 is a block diagram of a device for managing a self-balancing vehicle according to another exemplary embodiment of the present disclosure;

FIG. 45 is a block diagram of a device for managing a self-balancing vehicle according to another exemplary embodiment of the present disclosure;

FIG. 46 is a block diagram of a device for managing a self-balancing vehicle according to another exemplary embodiment of the present disclosure;

FIG. 47 is a block diagram of a device for managing a self-balancing vehicle according to another exemplary embodiment of the present disclosure;

FIG. 48 is a block diagram of a device for managing a self-balancing vehicle according to another exemplary embodiment of the present disclosure;

FIG. 49 is a block diagram of a device for managing a self-balancing vehicle according to another exemplary embodiment of the present disclosure;

FIG. 50 is a block diagram of a device for managing a self-balancing vehicle according to another exemplary embodiment of the present disclosure;

FIG. 51 is a block diagram of a device for managing a self-balancing vehicle according to another exemplary embodiment of the present disclosure;

FIG. 52 is a block diagram of a device for managing a self-balancing vehicle according to another exemplary embodiment of the present disclosure;

FIG. 53 is a block diagram of a device for managing a self-balancing vehicle according to another exemplary embodiment of the present disclosure; and

FIG. 54 illustrate an example of a self-balancing vehicle.

### DETAILED DESCRIPTION

Current Technology only allows a user who stands on a self-balancing vehicle to control the self-balancing vehicle through his/her feet or arms. The present disclosure provides an application that may be installed in a terminal (e.g., a mobile phone) to enable the terminal to control the self-balancing vehicle via blue-tooth connection, thereby enhancing user experiences with the self-balancing vehicle. For example, with the application, the terminal may be able to display speed, battery percentage of the self-balancing vehicle to a user. The terminal may also display a dashboard to allow the user to manually adjust the speed of the self-balancing vehicle thereon.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terms used herein are merely for describing a particular embodiment, rather than limiting the present disclosure. As used in the present disclosure and the appended claims, terms in singular forms such as “a”, “said” and “the” are intended to also include plural forms, unless explicitly dictated otherwise. It should also be understood that the term “and/or” used herein means any one or any possible combination of one or more associated listed items.

It should be understood that, although it may describe an element with a term first, second, or third, etc., the element is not limited by these terms. These terms are merely for distinguishing among elements of the same kind. For example, without departing from the scope of the present disclosure, a first element may also be referred to as a second element. Similarly, a second element may also be referred to as a first element. Depending on the context, a term “if” as used herein may be interpreted as “when”, “where” or “in response to”.

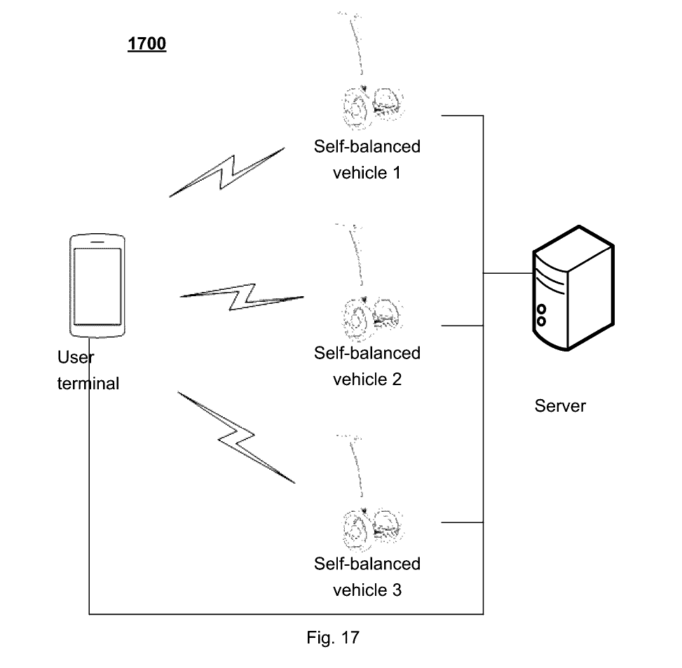

FIG. 17 is a diagram illustrating a system that may implement methods disclosed in the present disclosure.

The system 1700 may include a user terminal and at least one self-balancing vehicle. The user terminal may be a smart phone or any suitable devices. The self-balancing vehicle may be a machine that is structurally and/or dynamically unstable and/or unbalanced but may keep in a balanced position and move in the balanced position through real-time active control. For example, the self-balancing vehicle may be a Segway™ machine.

In the system 1700, the user terminal may be in communication with the at least one self-balancing vehicle via wireless connection, such as Bluetooth™ (hereinafter “Bluetooth”). Further, the user may search and find the at least one self-balancing vehicles and select one or more therefrom to control. For example, in FIG. 17, the user terminal may search and find that there are three self-balancing vehicles in connection or close enough to establish a connection: a self-balancing vehicle 1, a self-balancing vehicle 2, and a self-balancing vehicle 3. If the user selects the self-balancing vehicle 1, the user terminal may establish a Bluetooth connection with the self-balancing vehicle 1.

The system 1700 may further include a server. The server may have wireless connections with both the user terminal and the plurality of self-balancing vehicles, so that the server may collect usage information or other information of the self-balancing vehicles through the user terminal or directly from the plurality of self-balancing vehicles. The wireless connection may be of any type of connections commercially available, such as Internet or mobile network. With the usage information of each of the individual self-balancing vehicle, the server may analyze and obtain information of statistically how a self-balancing vehicle is used and what issue the self-balancing vehicle has.

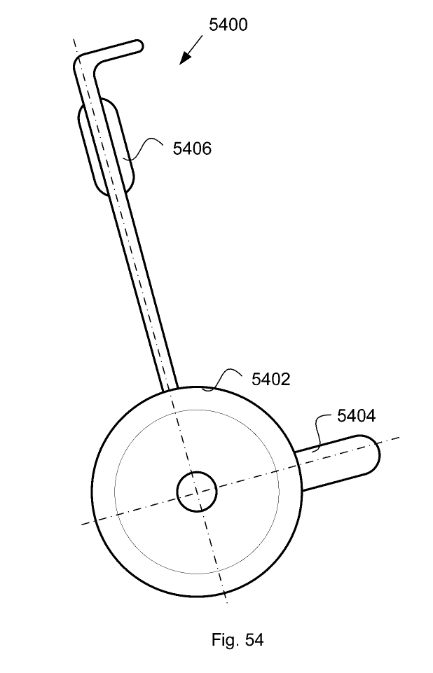

FIG. 54 is an example of a self-balancing vehicle. The self-balancing vehicle 5400 may include at least one wheel 5402 and a pad 5404 connected to the while 5402 for a user to stand thereon. This structure of the self-balancing vehicle 5400 is inherently unstable. Absent of active control, the vehicle 5400 may not stand upright on its own. The self-balancing vehicle 5400 may also include a control module 5406 to actively control the self-balancing vehicle 5400, so that when being activated, the self-balancing vehicle may stand upright as shown in FIG. 54 without falling. Upon receiving an instruction from a user, the control module 5406 may control the self-balancing vehicle to move forward, backward, turn right or left. The control module 5406 may also include hardware circuit to have wireless communications with external device. For example, the control module 5406 may be able to establish Bluetooth connections with at least one user terminal, and/or a server as shown in FIG. 17.

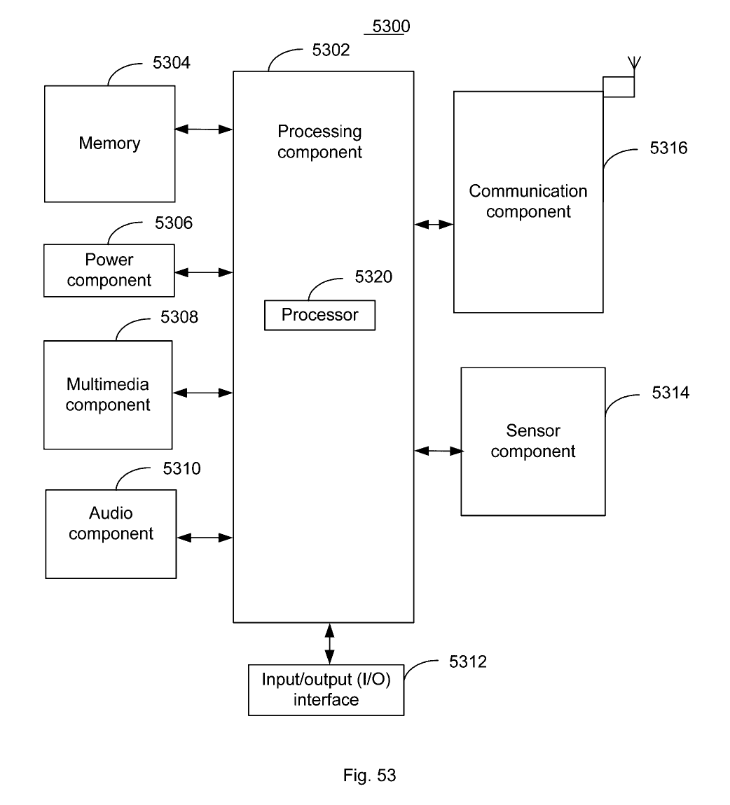

FIG. 53 is a block diagram of an electronic device 5300 (at a terminal side) for managing a self-balancing vehicle according to an exemplary embodiment. The device may implement the methods introduced in the present disclosure and serve as the user terminal in the system 1700. For example, the device 5300 may be a mobile phone, a computer, a digital broadcast terminal, a messaging device, a gaming console, a tablet, a medical device, exercise equipment, a personal digital assistant, and the like.

The device 5300 may include one or more of the following components: a processing component 5302, a memory 5304, a power component 5306, a multimedia component 5308, an audio component 5310, an input/output (I/O) interface 5312, a sensor component 5314, and a communication component 5316.

The processing component 5302 typically controls overall operations of the device 5300, such as the operations associated with display, telephone calls, data communications, camera operations, and recording operations. The processing component 5302 may include one or more processors 5320 to execute instructions to perform all or part of the methods introduced in the present disclosure. Moreover, the processing component 5302 may include one or more modules which facilitate the interaction between the processing component 5302 and other components. For instance, the processing component 5302 may include a multimedia module to facilitate the interaction between the multimedia component 5308 and the processing component 5302.

The memory 5304 may be configured to store various types of data to support the operation of the device 5300. Examples of such data may include instructions for any applications or methods operated on the device 5300, contact data, phonebook data, messages, pictures, video, etc. These applications may at least include an application for managing one or more self-balancing vehicles. The memory 5304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 5306 may provide power to various components of the device 5300. The power component 5306 may include a power management system, one or more power sources, and any other components associated with the generation, management, and distribution of power in the device 5300.

The multimedia component 5308 may include a screen providing an output interface between the device 5300 and the user. In some embodiments, the screen may include a liquid crystal display (LCD) and a touch panel (TP). If the screen may include the touch panel, the screen may be implemented as a touch screen to receive input signals from the user. The touch panel may include one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 5308 may include a front camera and/or a rear camera. The front camera and the rear camera may receive an external multimedia datum while the device 5300 is in an operation mode, such as a photographing mode or a video mode. Each of the front camera and the rear camera may be a fixed optical lens system or have focus and optical zoom capability.

The audio component 5310 may be configured to output and/or input audio signals. For example, the audio component 5310 may include a microphone (“MIC”) configured to receive an external audio signal when the device 5300 is in an operation mode, such as a call mode, a recording mode, and a voice recognition mode. The received audio signal may be further stored in the memory 5304 or transmitted via the communication component 5316. In some embodiments, the audio component 5310 further may include a speaker to output audio signals.

The I/O interface 5312 may provide an interface between the processing component 5302 and peripheral interface modules, such as a keyboard, a click wheel, buttons, and the like. The buttons may include, but are not limited to, a home button, a volume button, a starting button, and a locking button.

The sensor component 5314 may include one or more sensors to provide status assessments of various aspects of the device 5300. For instance, the sensor component 5314 may detect an open/closed status of the device 5300, relative positioning of components, e.g., the display and the keypad, of the device 5300, a change in position of the device 5300 or a component of the device 5300, a presence or absence of user contact with the device 5300, an orientation or an acceleration/deceleration of the device 5300, and a change in temperature of the device 5300. The sensor component 5314 may include a proximity sensor configured to detect the presence of nearby objects without any physical contact. The sensor component 5314 may further include a light sensor, such as a CMOS or CCD image sensor, for use in imaging applications. In some embodiments, the sensor component 5314 may further include an accelerometer sensor, a gyroscope sensor, a magnetic sensor, a pressure sensor, a microwave sensor or a temperature sensor.

The communication component 5316 may be configured to facilitate communication, wired or wirelessly, between the device 5300 and other devices. The device 5300 may access a wireless network based on a communication standard, such as WiFi, 2G, or 3G, or a combination thereof. In one exemplary embodiment, the communication component 5316 receives a broadcast signal or broadcast associated information from an external broadcast management system via a broadcast channel. In one exemplary embodiment, the communication component 5316 further may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 5300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is further provided a non-transitory computer readable storage medium including instructions, such as included in the memory 5304, executable by the processor 5320 in the device 5300, for performing the above-described methods. For example, the non-transitory computer-readable storage medium may be a ROM, a RAM, a CD-ROM, a magnetic tape, a floppy disc, an optical data storage device, and the like.

FIG. 1 is a flowchart of a method for managing a self-balancing vehicle according to an exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the following steps.

In step 110, a connection with a self-balancing vehicle is established through Bluetooth.

In the embodiment of the present disclosure, after the user terminal establishes a connection with the self-balancing vehicle through Bluetooth, it may exchange data with the self-balancing vehicle in a short range through Bluetooth. Wherein the self-balancing vehicle may be selected by the user and may accept management by the user.

To this end, the user may first identify a self-balancing vehicle and instruct the user terminal to establish a connection with the selected self-balancing vehicle. When receiving the instruction from the user, the user terminal may scan and make sure the self-balancing vehicle is Bluetooth capable. If yes, the user terminal may check if the Bluetooth settings of the self-balancing vehicle are compatible with the Bluetooth settings of the user terminal. If yes, the user terminal may send a signal to the self-balancing vehicle, requesting for establishing a communication connection. The self-balancing vehicle, with proper settings, may respond to the request. Accordingly, upon the instruction from the user, the user terminal and self-balancing vehicle may automatically establish a Bluetooth connection and start to communicate. Via the Bluetooth connection, the user terminal may send instructions to the self-balancing vehicle.

In step 120, status information of the self-balancing vehicle is acquired through the Bluetooth connection.

In the embodiment of the present disclosure, the user terminal may acquire and/or obtain status information of the self-balancing vehicle. The status information of the self-balancing vehicle may include at least one of a current remaining battery power, a current locked state or a current unlocked state, a current light color, a current navigation direction, a current navigation speed, a current body temperature and a current location.

The user terminal may obtain the status information of the self-balancing vehicle by actively send out an inquiry. Upon receipt of the inquiry, the self-balancing vehicle may collect the inquired status information of itself, and send the collected information to the user terminal via the Bluetooth connection. The user terminal may inquire and obtain some status information once upon the user's instruction. For example, when the self-balancing terminal is inactive and locked, the user terminal may just inquire the locking status of the self-balancing terminal once. If the user determines to use and/or control the self-balancing vehicle, the user terminal may instruct the self-balancing vehicle to unlock. The user terminal may, however, send battery status inquire periodically (e.g., every 5 seconds) in order to monitor the battery usage of the self-balancing vehicle.

In step 130, the self-balancing vehicle is managed according to the status information of the self-balancing vehicle.

In the embodiment of the present disclosure, the user terminal may provide the user a platform that can manage the self-balancing vehicle, i.e. a management interface of the self-balancing vehicle. In addition, the management interface may display status information of the self-balancing vehicle, to facilitate the user to manage the self-balancing vehicle according to the status information of the self-balancing vehicle.

For example, if the current light color of the self-balancing vehicle is white but the user prefers blue, the user may set the light color to be blue through the management interface.

It can be seen from the above embodiment that, the user terminal establishes a connection with the self-balancing vehicle through Bluetooth; acquires status information of the self-balancing vehicle through the Bluetooth connection; and manages the self-balancing vehicle according to the status information of the self-balancing vehicle. Thereby, the user terminal may manage the navigation state of the self-balancing vehicle through Bluetooth connection. Thus, it not only improves the management efficiency of the self-balancing vehicle, but also brings convenience for the user to manage the self-balancing vehicle, and improves the user experience.

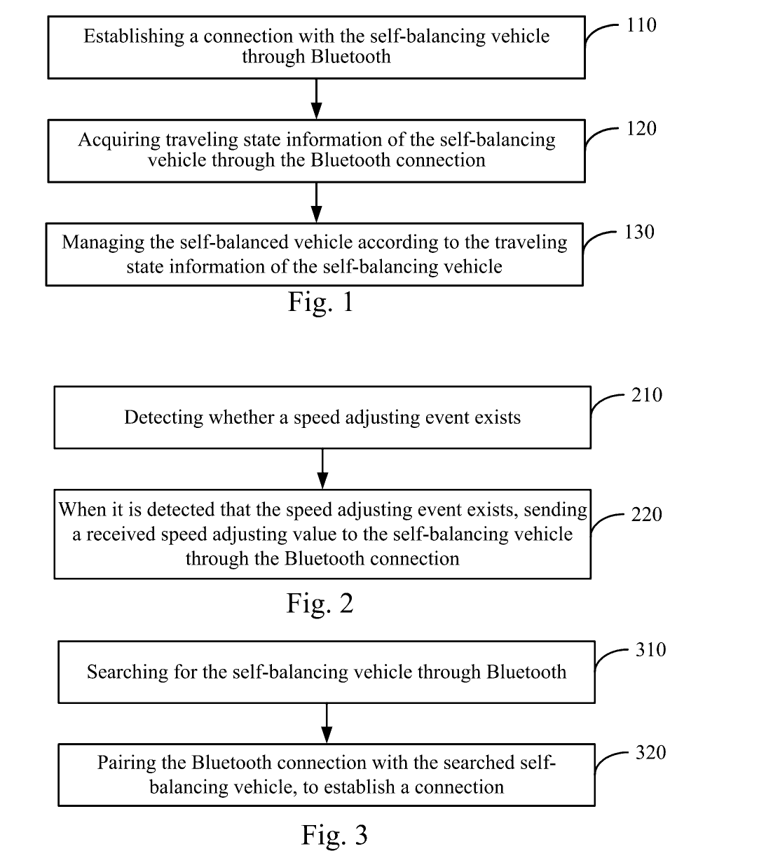

FIG. 2 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 2 may further include the following steps.

In step 210, the user terminal detects and/or determines whether a speed-adjusting event occurs.

In the embodiment of the present disclosure, the speed-adjusting event may be automatically triggered by the user terminal according to the status information of the self-balancing vehicle. For example, when the navigation speed of the self-balancing vehicle is too fast and the navigation speed of the self-balancing vehicle needs to be adjusted, the user terminal may automatically trigger a speed-adjusting event. In addition, the speed-adjusting event may also be triggered by the user. For example, when the user needs to adjust the navigation speed of the self-balancing vehicle, he may also trigger the speed-adjusting event.

In an implementation, when the user terminal detects whether a speed-adjusting event occurs, at least one of the following two ways may be adopted by the user terminal.

First way: the user terminal may detect whether an operation event for adjusting speed amplitude of the self-balancing vehicle occurs on a dashboard in a management interface.

In the embodiment of the present disclosure, the management interface may include a dashboard, on which a moving point that the user can drag is provided. A distance between the moving point and a reference point, such as a central point, of the dashboard may indicate speed amplitude. The larger the distance between the moving point and the central point of the dashboard is, the larger the speed amplitude is, which represents a higher navigation speed of the self-balancing vehicle. Therefore, the user may drag the moving point to move in the dashboard for adjusting the navigation speed of the self-balancing vehicle.

Second way: the user terminal may detect whether an operation event for adjusting a speed-controlling bar occurs on the management interface.

In the embodiment of the present disclosure, the management interface may include a speed-controlling bar, on which a moving point that the user can drag is provided. A linear distance between the moving point and a reference, such as a starting end of the speed-controlling bar, may indicate speed amplitude. The larger the linear distance between the moving point and the starting end of the speed-controlling bar is, the larger the speed amplitude is, which represents a higher navigation speed of the self-balancing vehicle. Therefore, the user may drag the moving point to move on the speed-controlling bar for adjusting the navigation speed of the self-balancing vehicle accordingly.

In step 220, when the user terminal detects that the speed-adjusting event occurs, a received speed adjusting value is sent to the self-balance vehicle through the Bluetooth connection.

When the user adjust the speed of the self-balancing vehicle through the interface of the user terminal, the user terminal may detects the speed-adjusting event. The user terminal may receive the adjustment that the user performed to the speed-controlling bar or the dashboard, and then determine an adjusted speed accordingly. Then the user terminal may send a speed adjustment signal corresponding to the adjusted speed to the self-balancing vehicle through the Bluetooth communication and adjust the navigation speed of the self-balancing vehicle accordingly.

It can be seen from the above embodiment that, the user terminal supports to adjust speed of the self-balancing vehicle, sends the speed adjusting value of the user to the self-balancing vehicle through the Bluetooth connection, which satisfies the speed adjusting need of the user with respect to the self-balancing vehicle, and improves the user experience.

FIG. 3 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. According to FIG. 3, the step 110 of establishing a connection with the self-balancing vehicle through Bluetooth may further include the following steps.

In step 310, the user terminal may search the self-balancing vehicle through Bluetooth.

In the embodiment of the present disclosure, when the self-balancing vehicle is searched for through Bluetooth, one self-balancing vehicle or a plurality of self-balancing vehicles may be found.

In step 320, the Bluetooth connection with the self-balancing vehicle the user terminal found is paired, to establish a connection.

In the embodiment of the present disclosure, if only one self-balancing vehicle is found, the user terminal may pair up itself with the self-balancing vehicle and establish the Bluetooth connection with the self-balancing vehicle; if a plurality of self-balancing vehicles are found, the user terminal may establish the connection with the plurality of self-balancing vehicles, or the user may select one or more self-balancing vehicles from the plurality of self-balancing vehicles as needed.

In an implementation, when performing the step 320 of pairing the Bluetooth connection with the self-balancing vehicle the user terminal found, to establish a connection, the following way may be further adopted:

When a number of the self-balancing vehicle the user terminal found is more than one, the user may select one or more self-balancing vehicles from the interface. The user terminal may receive a selecting instruction with respect to the self-balancing vehicle from the user, and establish the connection with the self-balancing vehicle selected by the user according to the selecting instruction.

It can be seen from the above embodiment that, the user terminal may search for the self-balancing vehicle through Bluetooth, and establish the Bluetooth connection with the self-balancing vehicle. In particular, the user terminal may establish a connection with the self-balancing vehicle selected by the user, which saves time for the user to search for the self-balancing vehicle and improves the efficiency of searching for the self-balancing vehicle by the user.

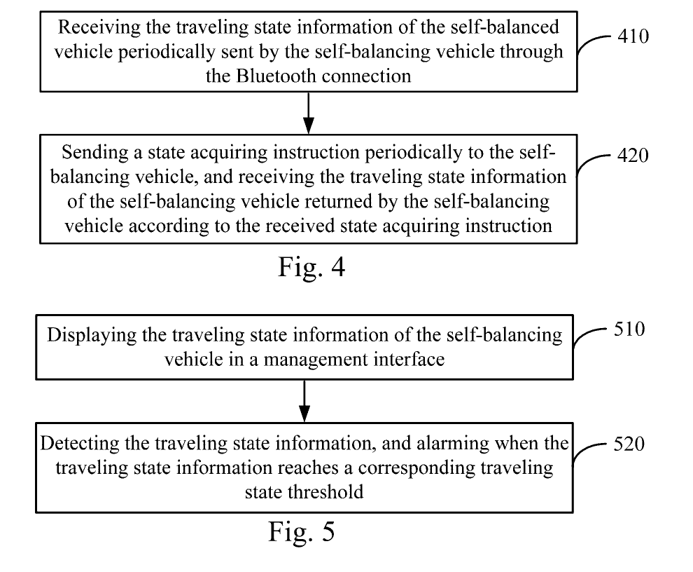

FIG. 4 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. According to FIG. 4, the step 120 of acquiring status information of the self-balancing vehicle through the Bluetooth connection may include step 410 or step 420.

In step 410, the status information of the self-balancing vehicle periodically sent by the self-balancing vehicle is received through the Bluetooth connection.

In step 420, a state acquiring instruction is periodically sent to the self-balancing vehicle, and the status information of the self-balancing vehicle returned by the self-balancing vehicle according to the received state acquiring instruction is received.

The above step 410 is a passive receiving way, and the step 420 is an active acquiring way, both of which aim to acquire the status information of the self-balancing vehicle, and then display the information in the management interface, to facilitate the user to manage the self-balancing vehicle according to the information.

In the embodiment of the present disclosure, when the user terminal manages the self-balancing vehicle, the status information of the self-balancing vehicle needs to be acquired. The status information of the self-balancing vehicle may be acquired by a passive receiving way or an active acquiring way, thus improving the efficiency of acquiring the status information of the self-balancing vehicle by the user terminal.

FIG. 5 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. According to FIG. 5, the step 130 of managing the self-balancing vehicle according to the status information of the self-balancing vehicle may include step 510 and/or step 520.

In step 510, the status information of the self-balancing vehicle is displayed in a management interface.

In the embodiment of the present disclosure, the management interface is a platform provided by the user terminal for the user to manage the self-balancing vehicle. The user terminal may display the status information of the self-balancing vehicle on the interface, to facilitate the user to manage the self-balancing vehicle according to the information.

In an implementation, in the step 510 of displaying the status information of the self-balancing vehicle in a management interface, corresponding display is performed according to different status information:

displaying a navigation speed of the self-balancing vehicle in the management interface; and/or

displaying a remaining battery power of the self-balancing vehicle in the management interface; and/or

displaying a body temperature of the self-balancing vehicle in the management interface.

For example, the displaying content in the management interface may include: the navigation speed of the self-balancing vehicle being 05km/h, the remaining battery power being 40%, the remaining cursing mileage being 20 km, or the like.

In an implementation, in the step 510 of displaying the status information in a management interface, it may further include the following content:

when the status information of the self-balancing vehicle contains a remaining battery power, calculating a remaining cursing mileage according to the remaining battery power; and displaying the remaining cursing mileage in the management interface.

Further In an implementation, when a remaining cursing mileage is calculated according to the remaining battery power, the remaining cursing mileage may be obtained based on a product of the remaining battery power and a configurable correlation coefficient, as shown in formula (1).

The remaining cursing mileage=the remaining battery power×the configurable correlation coefficient formula (1)

Wherein the configurable correlation coefficient may be a value configured by practical experience. For example, the configurable correlation coefficient may incorporate one or more coefficients reflecting aging condition of the battery, usage condition of the self-balancing vehicle, and/or environmental condition etc. These coefficients may affect the overall performance of the self-balancing vehicle, so that for certain amount of battery power, the self-balancing vehicle with different configurable correlation coefficient may curse different miles.

For example, the display content of the management interface further may include: the body temperature being 45°.

In step 520, the status information is detected, and it is alarmed when the status information reaches a corresponding navigation state threshold.

In the embodiment of the present disclosure, the user terminal may continuously and real-time detect and/or monitors the status information of the self-balancing vehicle, and then send out an alert to the user if the status information of the self-balancing vehicle reaches the navigation state threshold. There are many alarming ways, for example, it may be a color warning (emitting flash light or display predetermined color or pattern on the user terminal's screen, e.g.,), a sound warning (e.g., making a predetermined sound, such as an alarm) or the like.

In an implementation, in the step 510 of alarming when the status information of the self-balancing vehicle reaches a corresponding navigation state threshold, corresponding alarms are conducted according to different navigation state thresholds:

Alarming when a remaining battery power of the self-balancing vehicle is below a battery power threshold; and/or

Alarming when a navigation speed of the self-balancing vehicle is higher than a speed threshold; and/or

Alarming when a body temperature of the self-balancing vehicle is higher than a temperature threshold.

For example, when the remaining battery power of the self-balancing vehicle is higher than the battery power threshold, the display color of the remaining battery power of the self-balancing vehicle is green, which indicates that the remaining battery power of the self-balancing vehicle is normal; when the remaining battery power of the self-balancing vehicle equals to the battery power threshold, the display color of the remaining battery power of the self-balancing vehicle is yellow, which indicates that the remaining battery power of the self-balancing vehicle reaches a critical value; when the remaining battery power of the self-balancing vehicle is below the battery power threshold, the display color of the remaining battery power of the self-balancing vehicle is red, which indicates that the remaining battery power of the self-balancing vehicle is too low and the self-balancing vehicle needs to be charged, so that the user may charge the self-balancing vehicle timely upon he sees red.

It can be seen from the above embodiment that, the user terminal displays the status information of the self-balancing vehicle in the management interface, and detects the status information. When any information among the status information reaches corresponding navigation state threshold, it is alarmed. Therefore, the user may take corresponding safety measures for the self-balancing vehicle according to different alarms of the user terminal, which may improve the safety for the user to use the self-balancing vehicle and improve the user experience.

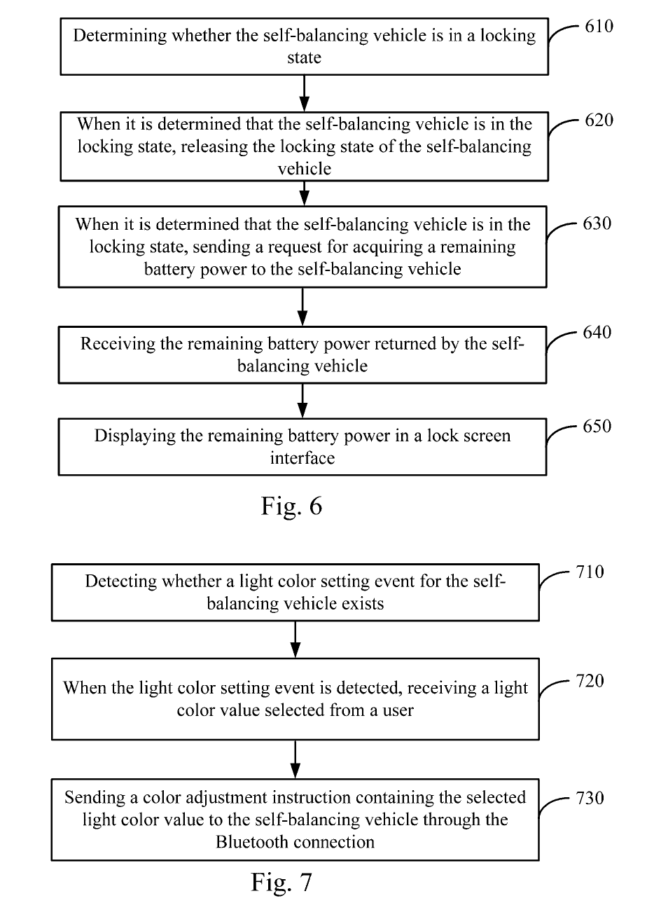

FIG. 6 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 6 may further include the following steps.

In step 610, determining whether the self-balancing vehicle is in a locked state.

In a locked state, the self-balancing vehicle may be locked and may not move. The self-balancing vehicle has to be unlocked in order to move. In the embodiment of the present disclosure, the user terminal may display whether the self-balancing vehicle is locked. When the status information of the self-balancing vehicle includes a locked state or an unlocked state of the self-balancing vehicle, the user terminal may determine whether the self-balancing vehicle is in the locked state from the status information of the self-balancing vehicle.

In step 620, when the user terminal determines that the self-balancing vehicle is in the locked state, the user terminal may release the locked state of the self-balancing vehicle upon receiving a user's instruction.

In the embodiment of the present disclosure, when the user terminal receives an instruction from the user to unlock the self-balancing vehicle (e.g., when the user wishes to use the self-balancing vehicle), the user terminal may release the locked state of the self-balancing vehicle according to the instruction of the user.

In an implementation, the following way may be adopted to release the locked state of the self-balancing vehicle.

When an operation of releasing locking is detected, an unlocking instruction is sent to the self-balancing vehicle through the connection, such that the self-balancing vehicle releases the locked state according to the received unlocking instruction.

Wherein the locking releasing activation operation may be triggered by the user.

In an implementation, after the step 610 of determining whether the self-balancing vehicle is in a locked state, the method may further include the following steps.

In step 630, when the user terminal determines that the self-balancing vehicle is in the locked state, the user terminal may send a request for acquiring a remaining battery power to the self-balancing vehicle.

In step 640, the remaining battery power returned by the self-balancing vehicle and is received by the user terminal.

In step 650, the user terminal displays the remaining battery power in a lock screen interface.

Further in an implementation, after the step 640 of receiving the remaining battery power returned by the self-balancing vehicle, the user terminal may also calculate a remaining cursing mileage according to the remaining battery power, and the remaining cursing mileage may be displayed on the lock screen interface. Wherein one way to calculate the remaining cursing mileage may be shown as formula (1).

In the embodiment of the present disclosure, when the self-balancing vehicle is in a locked state, the user terminal may further acquire a remaining battery power and a remaining cursing mileage of the self-balancing vehicle, and display the remaining battery power and remaining cursing mileage of the self-balancing vehicle on a lock screen interface. Therefore, the user may determine whether to charge the self-balancing vehicle according to the remaining battery power and remaining cursing mileage of the self-balancing vehicle on the lock screen interface. Thus, it improves the user experience and also increases the safety to use the self-balancing vehicle.

FIG. 7 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 7 may further include the following steps.

In step 710, the user terminal detects whether a light color-setting event for the self-balancing vehicle occurs.

In the embodiment of the present disclosure, the light color-setting event may be triggered by the user. The user may set the light color by the light color-setting event. For example, the user may select various preset colors provided by the user terminal, and the user may further input specific color values, or the like.

In step 720, when the user terminal detects the light color-setting event, the user terminal may receive a light color value selected from the user. Or when the user terminal receives a light color value selection from the user, the user terminal determines that a light color change event occurs.

In step 730, the user terminal sends a color adjustment instruction containing the selected light color value to the self-balancing vehicle through the Bluetooth connection.

It can be seen from the above embodiment that, the user terminal may support the user to set light colors, and send a color adjustment instruction containing the selected light color value to the self-balancing vehicle through the Bluetooth connection. Therefore, it satisfies the need of the user to set the light colors, improving the user experience.

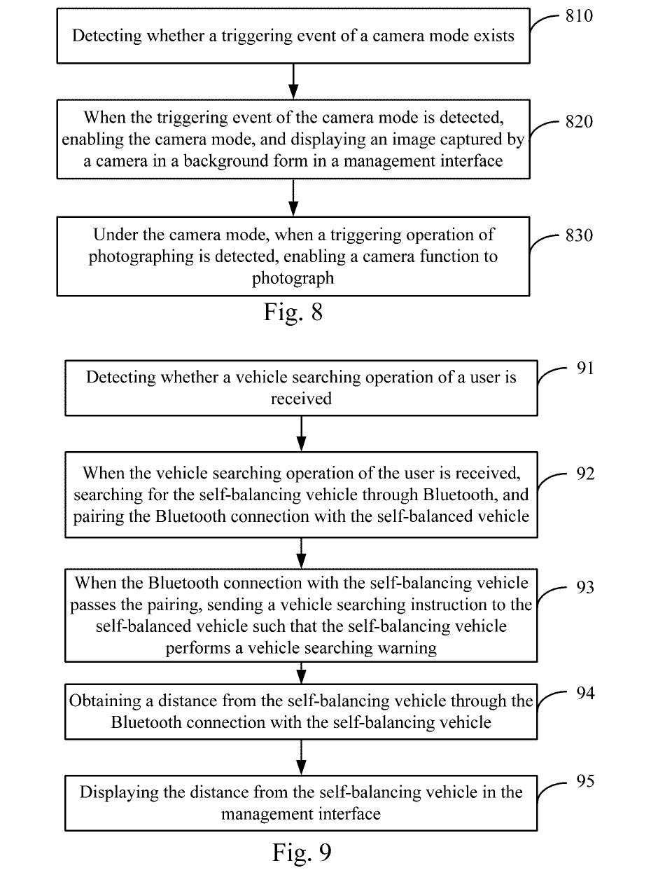

FIG. 8 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 8 may further include the following steps.

In step 810, the user terminal detects whether a activation event of a camera mode occurs.

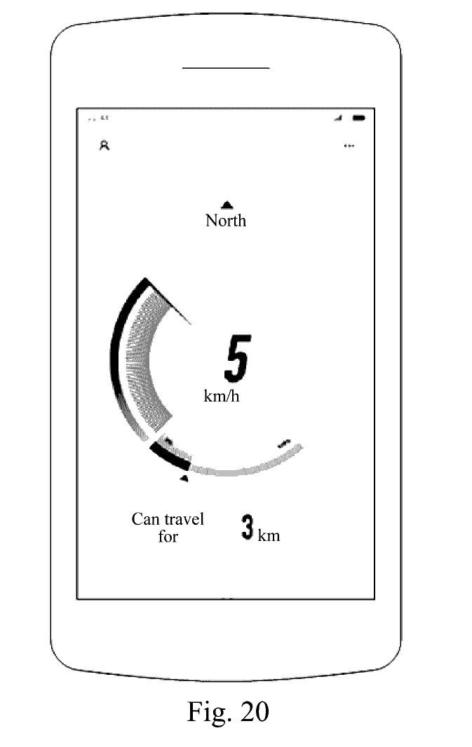

In the embodiment of the present disclosure, a shortcut to activate the camera is provided in the management interface. As shown in FIG. 20, the camera mode may be enabled by clicking the speed value (05 km/h) in the middle. The camera may be activated by the click and start to take ambient video or image. The self-balancing vehicle may transmit the video or image to the user terminal via the Bluetooth connection. The user terminal may directly display the ambient image or video captured by the camera, such as in a background form in a control interface. It avoids the situation where the user forgets to note the ambient environment when he uses the terminal, improving the user experience.

In step 820, when the activation event of the camera mode is detected, the camera mode is enabled, and an image captured by a camera is displayed in a background form in a management interface.

In the embodiment of the present disclosure, after the camera mode is enabled, an ambient image or video captured by the camera may be directly displayed in a background form in a control interface. It avoids the situation where the user forgets to note the ambient environment when he uses the terminal.

In an embodiment, in the step 820 of displaying an image captured by a camera in a background form in a management interface, the image captured by the camera may be embedded below a user interaction layer of the management interface in real time. Here, the user interaction layer may be a layer of the management interface that provide functions for a user to interact with the user terminal.

In the embodiment of the present disclosure, the management interface may include a plurality of layers. In order to guarantee the user can see the image captured by the camera while he is managing the self-balancing vehicle, the image captured by the camera is embedded below a user interaction layer of the management interface in real time.

In an embodiment, in the step 820 of displaying an image captured by a camera in a background form in a management interface, it may further include the following steps.

In step 830, under the camera mode, when the user terminal detects an operation from the user to take a photograph, the user terminal may instruct the self-balancing vehicle to enable a camera function to photograph.

In the embodiment of the present disclosure, there may be many ways for the user to trigger a photographing operation. The user may click a photographing button in the management interface, or press a physical key which triggers the photographing operation, for example, press a volume key.

It can be seen from the above embodiment that, the user terminal may support a camera mode, such that the user may also acquire the ambient environmental condition and photograph while he is managing the self-balancing vehicle. Thus, different needs of the user may be better satisfied, and the safety for the user to use the self-balancing vehicle is also improved.

FIG. 9 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 9 may further include the following steps.

In step 91, the user terminal detects whether it receives a vehicle searching operation from a user.

In the embodiment of the present disclosure, the management interface of the user terminal may provide to the user an option to conduct the vehicle searching operation. When the user needs to use a self-balancing vehicle, he may trigger the vehicle searching operation. The vehicle searching operation may be clicking a vehicle searching button in the management interface, may be pressing the physical key which triggers the vehicle searching operation, or may also be a voice instruction, or the like.

In step 92, when the vehicle searching operation of the user is received, the user terminal may search the vicinity of the user terminal. For example, the user terminal may send an inquiry to its surrounding and every activated self-balancing vehicle that has compatible Bluetooth capability within the range of Bluetooth communication (e.g., 100 meters or 328 feet) may respond to the inquiry. According, the user terminal may find one or more self-balancing vehicles around. Upon selection from the user, the user terminal may select a self-balancing vehicle through Bluetooth, and then pairs with the selected self-balancing vehicle through the Bluetooth connection, e.g. the user terminal may establish an initial Bluetooth connection with the selected self-balancing vehicle. For example, the initial Bluetooth connection may determine whether the user terminal and the self-balancing vehicle matches with each other in terms of Bluetooth connection, system compatibility, etc. to ensure that the user terminal and the self-balancing vehicle will have correct communication.

In step 93, when the Bluetooth connection with the self-balancing vehicle passes the pairing, the user terminal sends a vehicle searching instruction to the self-balancing vehicle such that the self-balancing vehicle performs a vehicle searching warning.

In the embodiment of the present disclosure, the vehicle searching warning may be a sound warning or a light warning, etc. for example, the search warning may be a predetermine color and/or flashing pattern of a light of the self-balancing vehicle, or a predetermined sound emitted by the self-balancing vehicle. By performing the warning, the self-balancing vehicle may be able to notify the user it is the vehicle being selected.

In an implementation, after the step 92 of searching for the self-balancing vehicle through Bluetooth and pairing the Bluetooth connection with the self-balancing vehicle, it may further include the following steps.

In step 94, a distance between the user terminal and the self-balancing vehicle is obtained through the Bluetooth connection with the self-balancing vehicle.

For example, the distance between the user terminal and the self-balancing vehicle is 5 meters.

In step 95, the distance from the self-balancing vehicle is displayed in the management interface.

It can be seen from the above embodiment that, the management interface of the user terminal supports vehicle searching function. It may not only acquire a vehicle searching warning but also acquire a distance from the self-balancing vehicle, which better satisfies the need of the user and improves the user experience.

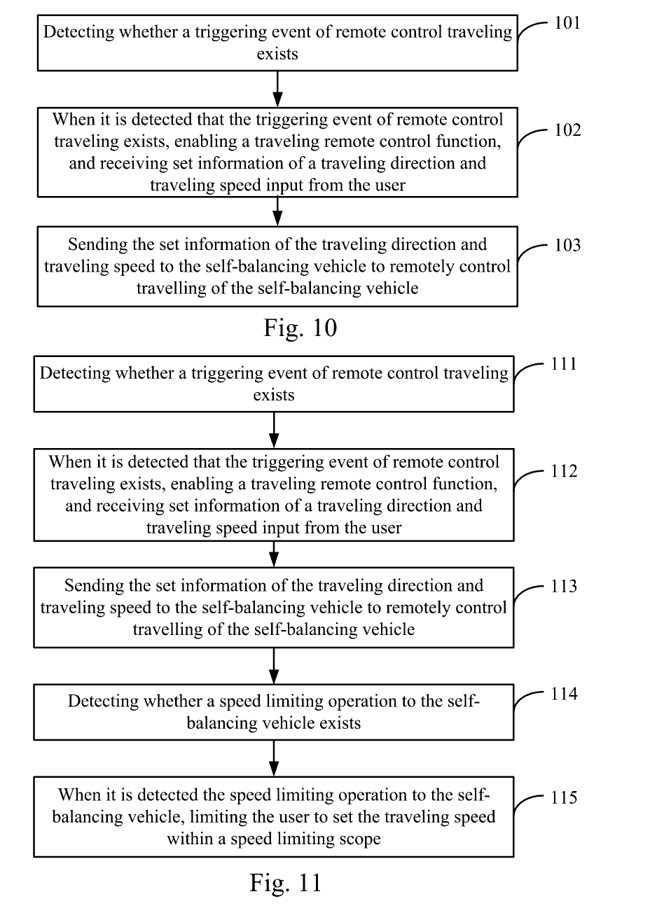

FIG. 10 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 9, the method in FIG. 10 may further include the following steps.

In step 101, the user terminal detects whether a activation event of remote control navigation occurs.

In step 102, when the user terminal detects that the activation event of remote control navigation occurs, it enables a navigation remote control function, and receives input information of a navigation direction and navigation speed input from the user.

In step 103, the input information of the navigation direction and navigation speed is sent to the self-balancing vehicle to remotely control travelling of the self-balancing vehicle.

In an embodiment, in the step 102 of enabling a navigation remote control function and receiving input information of a navigation direction and navigation speed input from the user, the user terminal may adopt the following processing ways:

(1) enabling the navigation remote control function, and detecting whether an setting event occurs (from the user) to set the travelling direction and navigation speed of the self-balancing vehicle occurs; and

(2) when the user terminal detects that the setting event for the travelling direction and navigation speed of the self-balancing vehicle occurs, the user terminal may check to receive and respond to input information of the navigation direction and navigation speed input from the user.

In an embodiment, in the above (1) of detecting whether an setting event for the travelling direction and navigation speed of the self-balancing vehicle occurs, it may adopt the following processing way:

detecting whether an operation event to adjust a directional angle of a dashboard in the management interface and adjust a distance from a center of the dashboard in the management interface occurs. The operation event may be executed by the user or someone else.

In the embodiment of the present disclosure, the management interface may include a dashboard. The user may achieve an objective of adjusting the navigation direction and navigation speed of the self-balancing vehicle by dragging a moveable point on the dashboard. For example, the movable point may be a button or a control point displayed on the dashboard movable by the user. The user may move the moveable point up, down, left and right to control motion of the self-balancing vehicle. The user terminal may send corresponding control signal to the self-balancing vehicle to instruct the self-balancing vehicle to navigate along a direction of forward, backward, towards the left, and towards the right. The user terminal senses a location of the moveable point and calculates an inclined angle between the location of the moveable point and 0° straight line at the center of the dashboard. The inclined angle is the directional angle of the self-balancing vehicle. Besides, a distance between the location of the moveable point and the center of the dashboard represents the navigation speed of the self-balancing vehicle.

It can be seen from the above embodiment that, the user terminal supports remote control function, the user terminal detects whether a activation event of remote control navigation occurs; if the activation event of remote control navigation is detected, a navigation remote control function is enabled, and input information of a navigation direction and navigation speed input from the user is received; the input information of the navigation direction and navigation speed is sent to the self-balancing vehicle to remotely control travelling of the self-balancing vehicle, which better satisfies the remote control need of the user and improves the user experience.

FIG. 11 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 10, the method in FIG. 10 may further include the following steps.

In step 111, the user terminal detects whether a activation event of remote control navigation occurs.

In the embodiment of the present disclosure, the management interface may include a dashboard. Clicking a central point of the dashboard may be a activation button of remote control navigation. When the user clicks the activation button of remote control navigation, it indicates that a activation event of remote control navigation occurs.

In step 112, when the user terminal detects that the activation event of remote control navigation occurs, a navigation remote control function is enabled, and input information of a navigation direction and navigation speed input from the user is received.

In the embodiment of the present disclosure, the input information of the navigation direction and navigation speed may be information directly input from the user, or it may be information obtained by the user terminal according to the user operation when the user performs different operations to the management interface.

In step 113, the input information of the navigation direction and navigation speed is sent to the self-balancing vehicle to remotely control travelling of the self-balancing vehicle.

For example, the user is apart from self-balancing vehicle for a certain distance, and the user may use the user terminal to remotely control the self-balancing vehicle to travel towards it, and it may also remotely control the navigation speed of the self-balancing vehicle.

In an implementation, the method for managing a self-balancing vehicle as shown in step 111 to step 113 may further include the following steps.

In step 114, the user terminal detects whether a speed limiting operation to the self-balancing vehicle occurs.

In the embodiment of the present disclosure, the speed limiting operation is to set a speed limiting value. The speed limiting value may be a speed limiting value directly input from the user, or a speed limiting value obtained by the user terminal according to the user operation when the user performs operation to the remote control navigation interface; it may also be a value preset by the user terminal or a value designated by a server.

In an implementation, detecting whether a speed limiting operation to the self-balancing vehicle occurs may use the following way:

Detecting whether a setting of highest navigation speed for a speed-controlling bar in a remote control navigation interface occurs.

In the embodiment of the present disclosure, the remote control navigation interface may include a speed-controlling bar, on which a moving point that the user can drag is provided. A linear distance between the moving point and a starting end of the speed-controlling bar may indicate a speed limiting value. The larger the linear distance between the moving point and the starting end of the speed-controlling bar is, the higher the speed limiting value of the self-balancing vehicle is. Therefore, the user may drag the moving point to move on the speed-controlling bar, to achieve an objective of limiting the navigation speed of the self-balancing vehicle.

In step 115, when the user terminal detects the speed limiting operation to the self-balancing vehicle, the user is limited to set the navigation speed within a speed limiting scope.

In the embodiment of the present disclosure, the remote control navigation interface may include a dashboard, on which a moving point that the user may drag is provided. A distance between the moving point and a reference point, such as a central point of the dashboard, may indicate speed amplitude. The larger the distance between the moving point and the central point of the dashboard is, the higher the navigation speed set by the user is. The largest distance between the moving point and the central point of the dashboard is smaller than or equals to the speed limiting value, wherein the speed limiting value is smaller than a speed limit that the self-balancing vehicle may reach. As a result, the user may only drag the moving point in the dashboard, i.e. the user may only set the navigation speed within a speed limiting scope.

It can be seen from the above embodiment that, the user terminal may support function of remotely controlling the self-balancing vehicle, send input information of a navigation direction and navigation speed of the user to the self-balancing vehicle to remotely control travelling of the self-balancing vehicle. Thus, the need of the user to remotely control the self-balancing vehicle is satisfied and the user experience is improved.

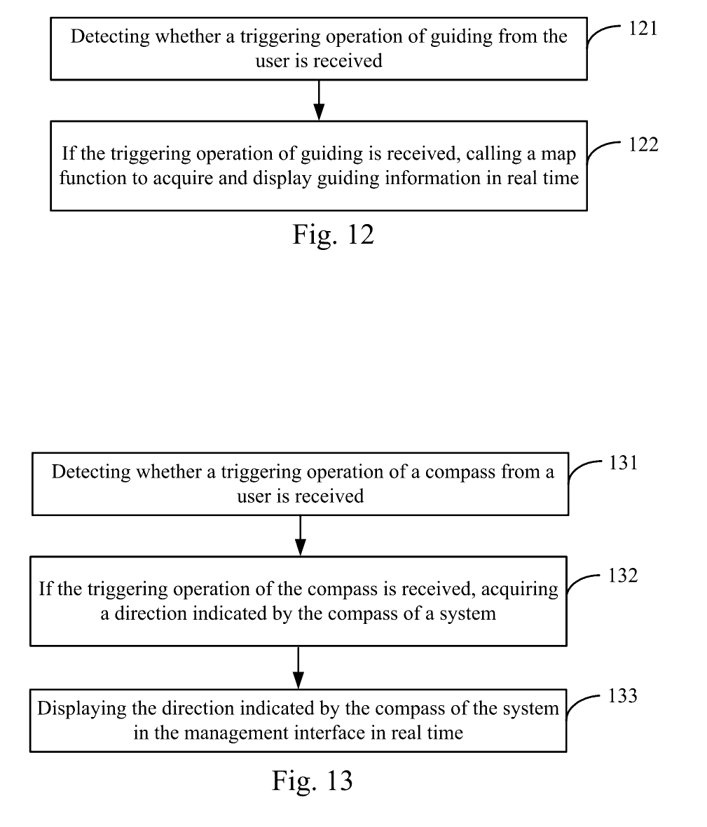

FIG. 12 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 12 may further include the following steps.

In step 121, the user terminal detects whether an operation of guiding from the user is received.

In the embodiment of the present disclosure, the management interface of the user terminal may include a guiding button, which is set for guiding the user. When the user clicks the guiding button, it indicates that the user has a need of guiding. For example, the user needs to locate the current location, and the clicking operation of the user may be the activation operation of guiding.

In step 122, if the activation operation of guiding is received, a map function is called to acquire and display guiding information in real time.

In the embodiment of the present disclosure, the user terminal may not only manage the self-balancing vehicle, but also call the map function, to satisfy the need of guiding of the user.

In an implementation, in the step 122, the calling a map function to acquire and display guiding information in real time may adopt the following way:

enabling the map function, and switching to a guiding interface to acquire and display a current location and guiding direction data in real time.

It can be seen from the above embodiment that, the user terminal may support guiding function, and may feedback the guiding information to the user according to the need of guiding in real time, such that the user may acquire the guiding information timely. Thus, it may avoid the user getting lost, improve the safety for the user to use the self-balancing vehicle and improve the user experience.

FIG. 13 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 13 may further include the following steps.

In step 131, the user terminal detects whether an operation of activate a compass from a user is received.

In the embodiment of the present disclosure, the activation operation of the compass aims to acquire directional information, and the activation operation of the compass may be triggered by the user or triggered by the user terminal separately.

In step 132, if the activation operation of the compass is received, a direction indicated by the compass of a system is acquired.

In step 133, the direction indicated by the compass of the system is displayed in the management interface in real time.

In the embodiment of the present disclosure, the management interface may include a dashboard, on which the direction indicated by the compass of a system may be displayed, so that the user may set the navigation direction of the self-balancing vehicle based on the direction.

It can be seen from the above embodiment that, the user terminal may support compass function. A direction indicated by the compass of a system may be displayed in the management interface in real time, such that the user may acquire the guiding information timely. Thus, it may avoid the user getting lost, improve the safety for the user to use the self-balancing vehicle and improve the user experience.

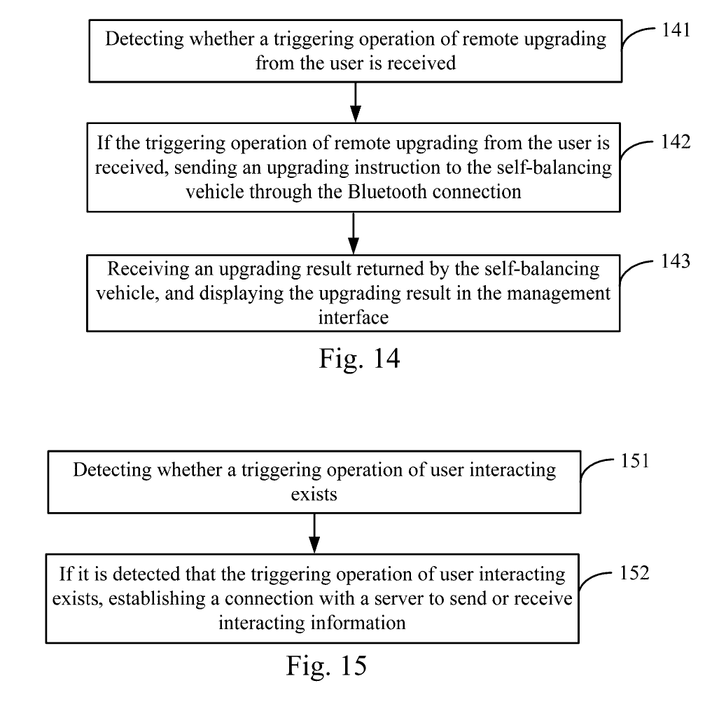

FIG. 14 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method of FIG. 14 may further include the following steps.

In step 141, the user terminal detects whether an operation to conduct remote upgrading from the user is received.

In the embodiment of the present disclosure, the activation operation of remote upgrading aims to upgrade the self-balancing vehicle, and the activation operation of remote upgrading may be triggered by the user or triggered by the user terminal separately, or it may also be triggered when the self-balancing vehicle itself needs upgrade.

In step 142, if the activation operation of remote upgrading from the user is received, an upgrading instruction is sent to the self-balancing vehicle through the Bluetooth connection.

In the embodiment of the present disclosure, the user terminal sends the upgrading instruction to the self-balancing vehicle. The self-balancing vehicle may be upgraded according to the upgrading instruction and returns an upgrading result to the user terminal.

In step 143, an upgrading result returned by the self-balancing vehicle is received, and the upgrading result is displayed in the management interface.

It can be seen from the above embodiment that, the user terminal may support remote upgrade function of the self-balancing vehicle, and send an upgrading instruction to the self-balancing vehicle through the Bluetooth connection, such that the self-balancing vehicle upgrades according to the upgrading instruction and returns an upgrading result to the user terminal, thus increasing management scope of the self-balancing vehicle, improving management efficiency of the self-balancing vehicle, and also improving the safety for the user to use the self-balancing vehicle.

FIG. 15 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method of FIG. 15 may further include the following steps.

In step 151, the user terminal detects whether an operation of conducting user interaction occurs.

In the embodiment of the present disclosure, when the user of the self-balancing vehicle is using the self-balancing vehicle, he may need to communicate with a user of other self-balancing vehicle. For example, users of a plurality of self-balancing vehicles may want to communicate and/or share his experiences or information with each other about performance of respective self-balancing vehicles. Therefore, the user terminal further may provide the user an interaction function, so that the users may interact with each other to coordinate, communication, or share information with each other based on a user account or by setting a forum. The coordinating, communication and/or sharing may include voice communication, video stream communication, text message communication or an instant communication means that one of ordinary skill in the art may perceive.

In step 152, if the user terminal detects that the activation operation of user interaction occurs, a connection is established with a server to send or receive interacting information.

It can be seen from the above embodiment that, the user terminal may support user interaction function, and establish a connection with a server to send or receive interacting information. Various needs of the user are satisfied and the user experience is improved.

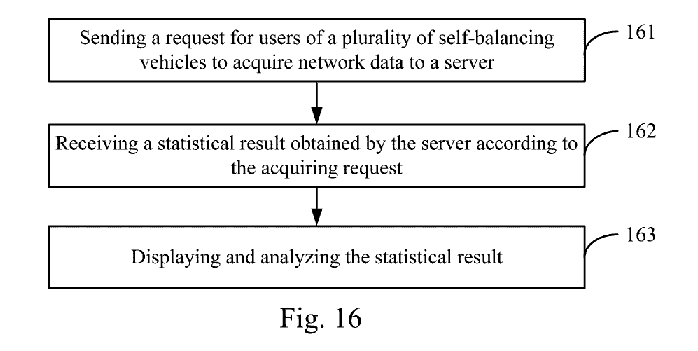

FIG. 16 is a flowchart illustrating a method for managing a self-balancing vehicle according to another exemplary embodiment of the present disclosure. The method may be implemented in the system 1700 and executed by a user terminal. For example, the user terminal may be the device 5300. To this end, the method may be implemented as a set of instructions and/or an application stored in a non-transitory storage medium of the device 5300, and may be executed by a processor of the 5300 to execute the method. In addition to the steps in the method as shown in FIG. 1, the method in FIG. 16 may further include the following steps.

In step 161, the user terminal sends a request to a server to obtain usage data of a plurality of self-balancing vehicles. The server may be the server shown in FIG. 17.

In the embodiment of the present disclosure, each the plurality of the self-balancing vehicle may be equipped to have wireless communications with the server. For each of the plurality of self-balancing vehicle, a user may instruct to send usage data of the self-balancing vehicles to the server. The server may collect the usage information and obtain statistical information of the usage of the plurality of self-balancing vehicles. The statistical information may be any information that that determinable by statistics. For example, the server may conduct statistic study to positions of the self-balancing vehicles and/or users and identify those what has similar position or navigation route. The server may also identify those self-balancing vehicles and/or users that historically navigated at certain average speed. This statistical information may be requested and sent to the user terminal.

The statistical information may be used to instruct users of respective self-balancing vehicles to better use the self-balancing vehicles. Therefore, users of respective self-balancing vehicles may also acquire the statistical usage information from the server, and use it as references for themselves to better use the self-balancing vehicles, for example, to reasonably set speed of the self-balancing vehicles.

In step 162, a statistical result obtained by the server according to the acquiring request is received.

In step 163, the statistical result is displayed and analyzed.

It can be seen from the above embodiment that, the user terminal may acquire and display a statistical result of the self-balancing vehicle of the server, to facilitate the user to better manage the self-balancing vehicle according to the statistical result. Thus, the user may manage the self-balancing vehicle more safely and more efficiently and improve the user experience.

Referring back to FIG. 17. FIG. 17 is a diagram illustrating an application scenario of a method for managing a self-balancing vehicle according to an exemplary embodiment of the present disclosure. The application scenario involves a user terminal and a self-balancing vehicle. Wherein there may be one or more self-balancing vehicles, and the user may select one or more self-balancing vehicles from the self-balancing vehicles that have been found and control them.

The user terminal searches for the self-balancing vehicle through Bluetooth, for example, searches for a self-balancing vehicle 1, a self-balancing vehicle 2, and a self-balancing vehicle 3.

If the user selects the self-balancing vehicle 1, the user terminal may establish a connection with the self-balancing vehicle 1 through Bluetooth.

The user terminal acquires the current state information of the self-balancing vehicle 1.

The user terminal acquires the status information of the self-balancing vehicle 1 through the Bluetooth connection.

The user terminal manages the self-balancing vehicle 1 according to the status information of the self-balancing vehicle.

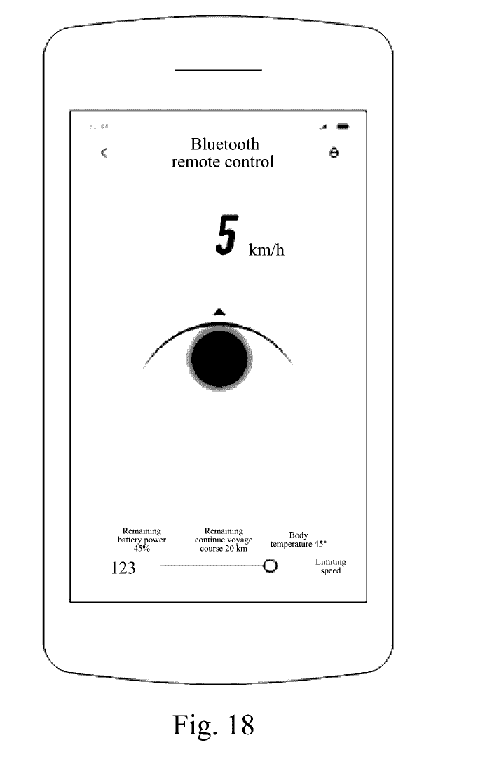

The management interface may include the status information of the self-balancing vehicle. As shown in FIG. 18, the navigation speed of the self-balancing vehicle is 05 km/h, the remaining battery power is 45%, the remaining continuous voyage course is 20 km, and the body temperature is 45°.

The management interface may include a dashboard. As shown in FIG. 18, the user may drag the black light ball to move in the dashboard to achieve an object of adjusting the speed of the self-balancing vehicle. Wherein a distance between the position of the black light ball and the center of the dashboard may represent the speed amplitude. The larger the distance is, the larger the speed amplitude, the higher the speed of the self-balancing vehicle is.

The management interface may include a speed-controlling bar. As shown in FIG. 18, the user may drag the moving point on the speed-controlling bar to achieve an object of adjusting the highest speed of the self-balancing vehicle. The 10 km/h displayed on the left of the speed-controlling bar is the highest navigation speed set by the user.

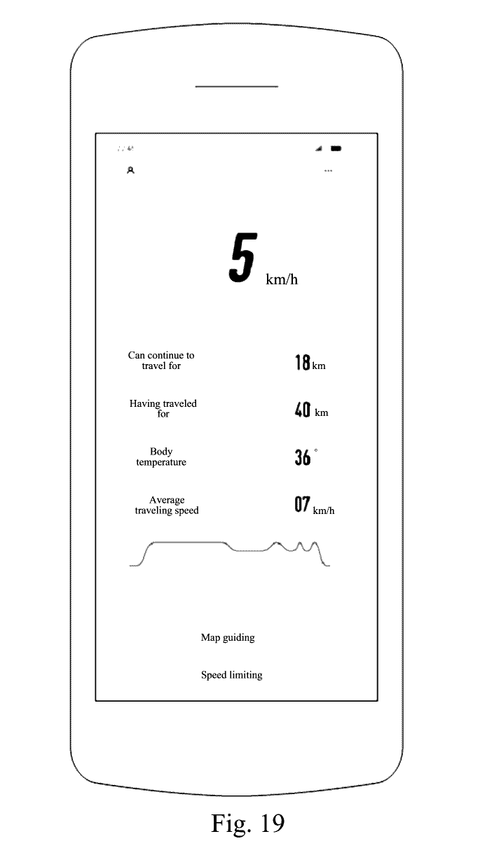

The management interface further may include a map-guiding button and a speed-limiting button. As shown in FIG. 19, the user may click the map-guiding button to conduct the map guiding, and may also click the speed limiting button to limit the speed. In addition, FIG. 19 further displays the statistic data of the self-balancing vehicle, for example: the self-balancing vehicle has traveled for 40 km, the average navigation speed is 7 km/h, or the like.

The management interface further may provide a shortcut to activate the camera. As shown in FIG. 20, the camera function may be enabled by clicking the speed value (05 km/h) in the middle, an ambient image or video captured by the camera of the cell phone is directly displayed in a background form in a control interface. It avoids the situation where the user forgets to note the ambient environment when he uses the terminal, improving the user experience.

The management interface may display a direction indicated by the compass of the system. For example, “north” in FIG. 20, it indicates that the current navigation direction of the self-balancing vehicle is “north”, so that the user may learn about the navigation direction of the self-balancing vehicle timely, avoiding the user getting lost.

Corresponding to the above method embodiments for managing a self-balancing vehicle, the present disclosure further may provide device embodiments.

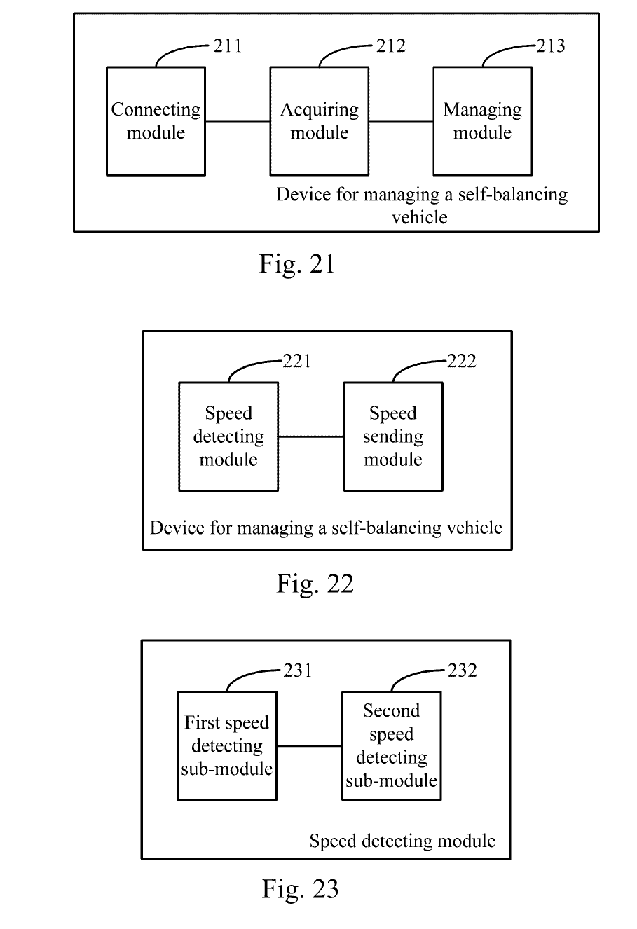

FIG. 21 is a block diagram of a device for managing a self-balancing vehicle according to an exemplary embodiment of the present disclosure, which is applied in a user terminal and configured to perform the method for managing a self-balancing vehicle as shown in FIG. 1. The device may include: a connecting module 211, an acquiring module 212 and a managing module 213.

Wherein the connecting module 211 may be configured to establish a connection with the self-balancing vehicle through Bluetooth;

the acquiring module 212 may be configured to acquire status information of the self-balancing vehicle through the connection; and

the managing module 213 may be configured to manage the self-balancing vehicle according to the status information of the self-balancing vehicle.

FIG. 22 is a block diagram of a device for managing a self-balancing vehicle according to another exemplary embodiment of the present disclosure, which is applied in a user terminal. Based on the device as shown in FIG. 21, the device further may include: a speed detecting module 221 and a speed sending module 222.

The speed detecting module 221 may be configured to detect whether a speed-adjusting event occurs; and

the speed sending module 222 may be configured to, when the user terminal detects that the speed-adjusting event occurs, send a received speed adjusting value to the self-balance vehicle through the connection.

FIG. 23 is a block diagram of a device for managing a self-balancing vehicle according to another exemplary embodiment of the present disclosure, which is applied in a user terminal. Based on the device as shown in FIG. 22, the speed detecting module 221 may include: a first speed detecting sub-module 231 or a second speed detecting sub-module 232.

Wherein the first speed detecting sub-module 231 may be configured to detect whether an operation event for adjusting speed amplitude of a dashboard in a management interface occurs; and

the second speed detecting sub-module 232 may be configured to detect whether an operation event for adjusting a speed-controlling bar in the management interface occurs.

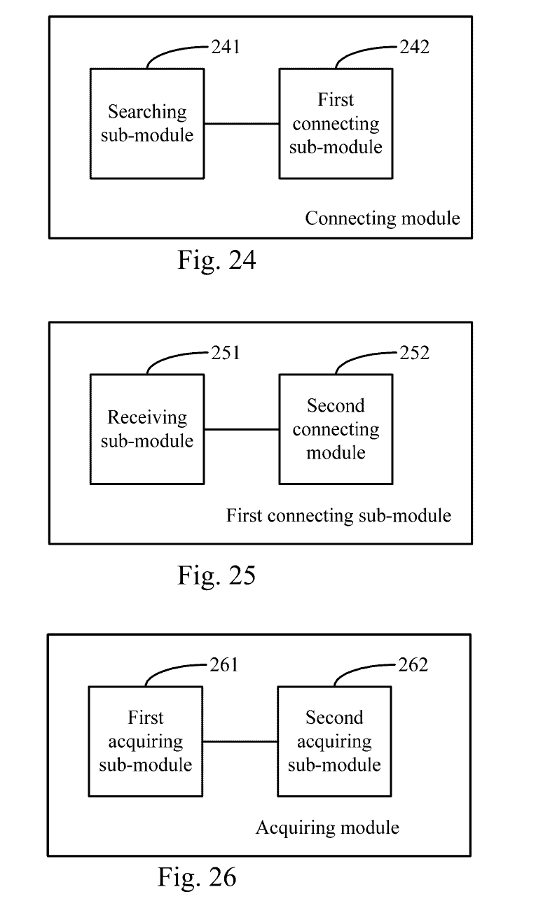

FIG. 24 is a block diagram of a device for managing a self-balancing vehicle according to another exemplary embodiment of the present disclosure, which is applied in a user terminal. Based on the device as shown in FIG. 21, the connecting module 211 may include: a searching sub-module 241 and a first connecting sub-module 242.

Wherein the searching sub-module 241 may be configured to search for the self-balancing vehicle through Bluetooth; and

the first connecting sub-module 242 may be configured to pair the Bluetooth connection with the self-balancing vehicle the user terminal found, to establish a connection.

FIG. 25 is a block diagram of a device for managing a self-balancing vehicle according to another exemplary embodiment of the present disclosure, which is applied in a user terminal. Based on the device as shown in FIG. 24, the first connecting sub-module further 242 may include: a receiving sub-module 251 and a second connecting module 252.

Wherein the receiving sub-module 251 may be configured to, when a number of the self-balancing vehicle the user terminal found is more than one, receive a selecting instruction with respect to the self-balancing vehicle; and

the second connecting module 252 may be configured to connect the self-balancing vehicle selected by the user according to the selecting instruction.

FIG. 26 is a block diagram of a device for managing a self-balancing vehicle according to another exemplary embodiment of the present disclosure, which is applied in a user terminal. Based on the device as shown in FIG. 21, the acquiring module 212 may include: a first acquiring sub-module 261 or a second acquiring sub-module 262.

Wherein the first acquiring sub-module 261 may be configured to receive the status information of the self-balancing vehicle periodically sent by the self-balancing vehicle through the connection; and

the second acquiring sub-module 262 may be configured to send a state acquiring instruction to the self-balancing vehicle periodically, and receive the status information of the self-balancing vehicle returned by the self-balancing vehicle according to the state acquiring instruction.

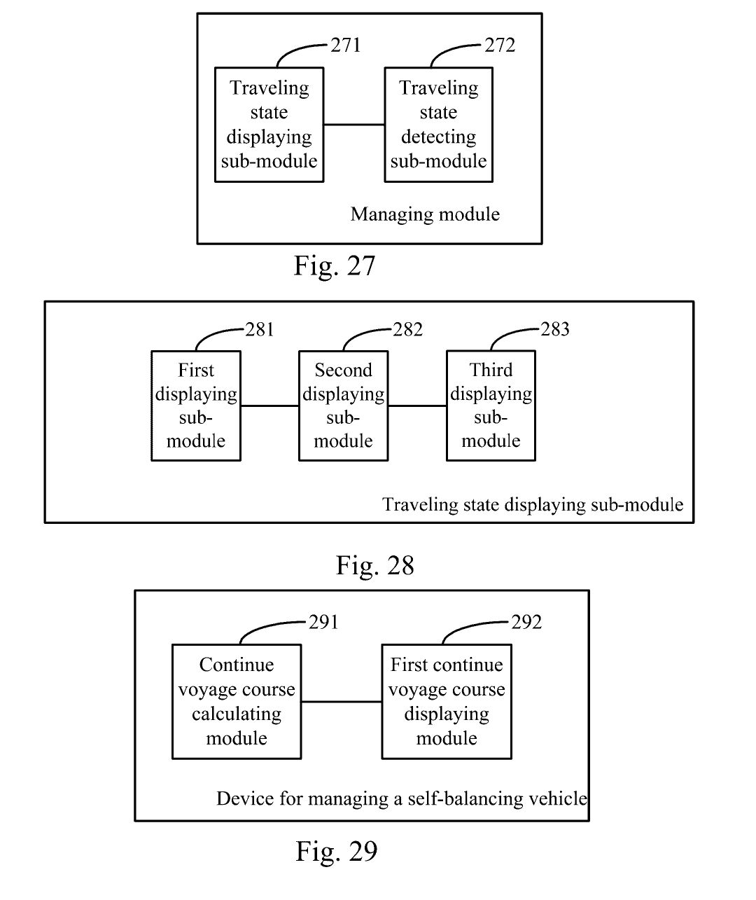

FIG. 27 is a block diagram of a device for managing a self-balancing vehicle according to another exemplary embodiment of the present disclosure, which is applied in a user terminal. Based on the device as shown in FIG. 21, the managing module 213 may include: a navigation state displaying sub-module 271 and/or a navigation state detecting sub-module 272.

Wherein the navigation state displaying sub-module 271 may be configured to display the status information in a management interface; and

the navigation state detecting sub-module 272 may be configured to detect the status information, and alarm when the status information reaches a corresponding navigation state threshold.

FIG. 28 is a block diagram of a device for managing a self-balancing vehicle according to another exemplary embodiment of the present disclosure, which is applied in a user terminal. Based on the device as shown in FIG. 27, the navigation state displaying sub-module 271 may include: a first displaying sub-module 281; and/or a second displaying sub-module 282; and/or a third displaying sub-module 283.

Wherein the first displaying sub-module 281 may be configured to display a navigation speed of the self-balancing vehicle in the management interface;

the second displaying sub-module 282 may be configured to display a remaining battery power of the self-balancing vehicle in the management interface; and

the third displaying sub-module 283 may be configured to display a body temperature of the self-balancing vehicle in the management interface.

FIG. 29 is a block diagram of a device for managing a self-balancing vehicle according to another exemplary embodiment of the present disclosure, which is applied in a user terminal. Based on the device as shown in FIG. 27, the device further may include: a cursing mileage calculating module 291 and a first cursing mileage displaying module 292.

Wherein the cursing mileage calculating module 291 may be configured to, when the status information contains a remaining battery power, calculate a remaining cursing mileage according to the remaining battery power; and

the first cursing mileage displaying module 292 may be configured to display the remaining cursing mileage in the management interface.

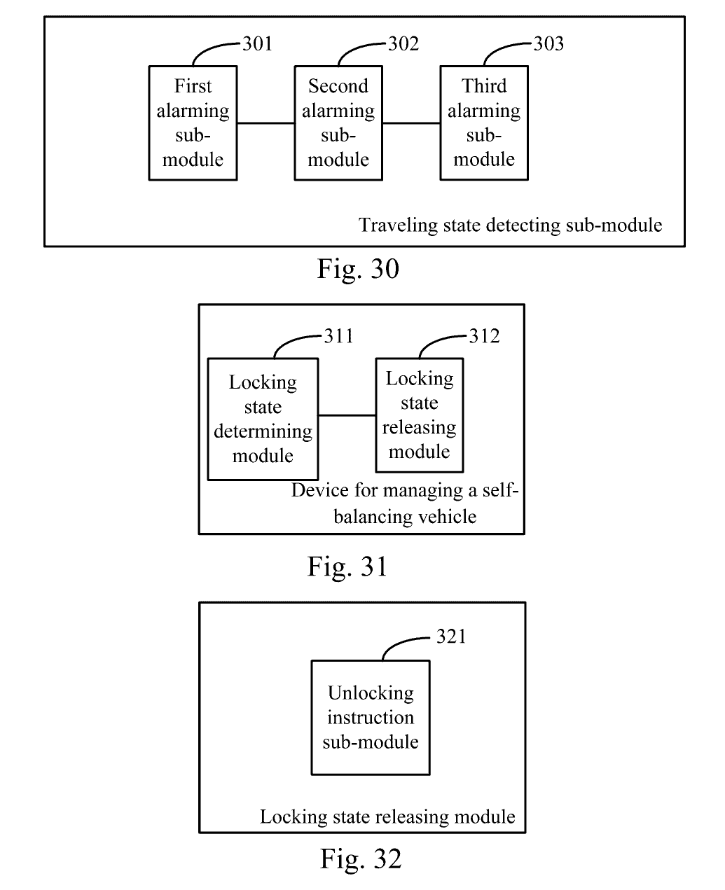

FIG. 30 is a block diagram of a device for managing a self-balancing vehicle according to another exemplary embodiment of the present disclosure, which is applied in a user terminal. Based on the device as shown in FIG. 27, the navigation state detecting sub-module 272 may include: a first alarming sub-module 301; and/or a second alarming sub-module 302; and/or a third alarming sub-module 303.

Wherein the first alarming sub-module 301 may be configured to alarm when a remaining battery power of the self-balancing vehicle is below a battery power threshold;

the second alarming sub-module 302 may be configured to alarm when a navigation speed of the self-balancing vehicle is higher than a speed threshold; and

the third alarming sub-module 303 may be configured to alarm when a body temperature of the self-balancing vehicle is higher than a temperature threshold.

FIG. 31 is a block diagram of a device for managing a self-balancing vehicle according to another exemplary embodiment of the present disclosure, which is applied in a user terminal. Based on the device as shown in FIG. 21, the device further may include: a locked state determining module 311 and a locked state releasing module 312.

Wherein the locked state determining module 311 may be configured to determine whether the self-balancing vehicle is in a locked state; and

the locked state releasing module 312 may be configured to, when it is determined that the self-balancing vehicle is in the locked state, release the locked state of the self-balancing vehicle.

FIG. 32 is a block diagram of a device for managing a self-balancing vehicle according to another exemplary embodiment of the present disclosure, which is applied in a user terminal. Based on the device as shown in FIG. 31, the locked state releasing module 312 may include: an unlocking instruction sub-module 321.

Wherein the unlocking instruction sub-module 321 may be configured to, when a activation operation of releasing locking is detected, send an unlocking instruction to the self-balancing vehicle through the connection, such that the self-balancing vehicle releases the locked state according to the received unlocking instruction.

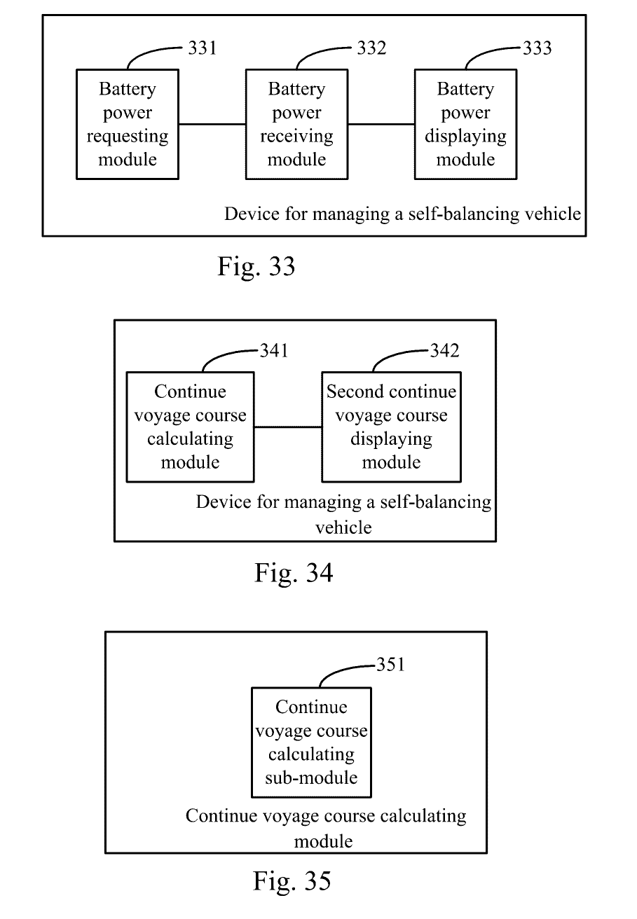

FIG. 33 is a block diagram of a device for managing a self-balancing vehicle according to another exemplary embodiment of the present disclosure, which is applied in a user terminal. Based on the device as shown in FIG. 31, the device further may include: a battery power requesting module 331, a battery power receiving module 332 and a battery power displaying module.

Wherein the battery power requesting module 331 may be configured to, when it is determined that the self-balancing vehicle is in the locked state, send a request for acquiring a remaining battery power to the self-balancing vehicle;

the battery power receiving module 332 may be configured to receive the remaining battery power returned by the self-balancing vehicle; and

the battery power displaying module 333 may be configured to display the remaining battery power in a lock screen interface.

FIG. 34 is a block diagram of a device for managing a self-balancing vehicle according to another exemplary embodiment of the present disclosure, which is applied in a user terminal. Based on the device as shown in FIG. 33, the device further may include: a cursing mileage calculating module 341 and a second cursing mileage displaying module 342.

Wherein the cursing mileage calculating module 341 may be configured to calculate a remaining cursing mileage according to the remaining battery power; and

the second cursing mileage displaying module 342 may be configured to display the remaining cursing mileage on the lock screen interface.

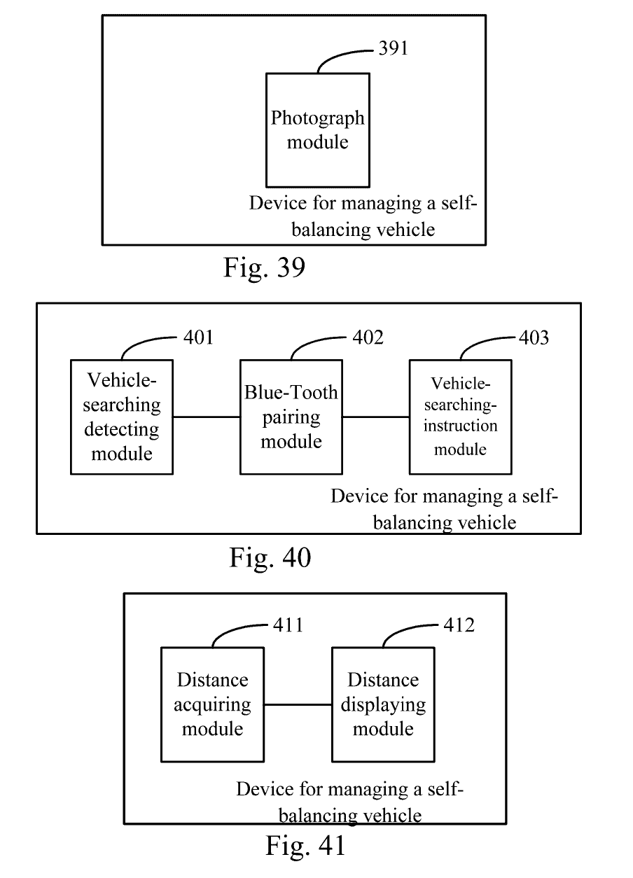

FIG. 35 is a block diagram of a device for managing a self-balancing vehicle according to another exemplary embodiment of the present disclosure, which is applied in a user terminal. Based on the device as shown in FIG. 39 or FIG. 34, the cursing mileage calculating module 291 or the cursing mileage calculating module 341 both include: a cursing mileage calculating sub-module 351.

Wherein the cursing mileage calculating sub-module 351 may be configured to obtain the remaining cursing mileage based on a product of the remaining battery power and a configurable correlation coefficient.

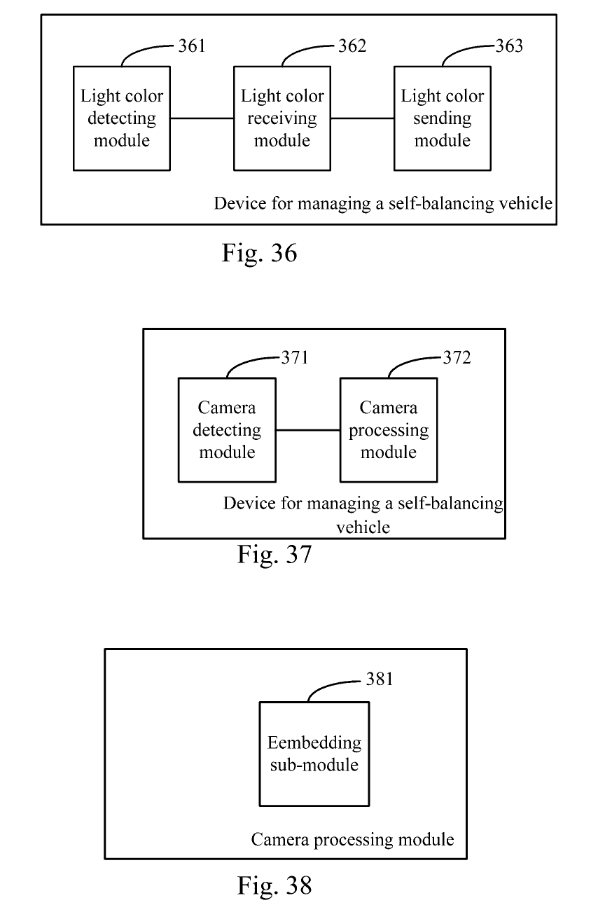

FIG. 36 is a block diagram of a device for managing a self-balancing vehicle according to another exemplary embodiment of the present disclosure, which is applied in a user terminal. Based on the device as shown in FIG. 21, the device further may include: a light color detecting module 361, a light color receiving module 362 and a light color sending module 363.

Wherein the light color detecting module 361 may be configured to detect whether a light color-setting event for the self-balancing vehicle occurs;

the light color receiving module 362 may be configured to, when the light color-setting event is detected, receive a light color value selected from a user; and

the light color sending module 363 may be configured to send a color adjustment instruction containing the selected light color value to the self-balancing vehicle through the connection.

FIG. 37 is a block diagram of a device for managing a self-balancing vehicle according to another exemplary embodiment of the present disclosure, which is applied in a user terminal. Based on the device as shown in FIG. 21, the device further may include: a camera detecting module 371 and a camera processing module 372.

Wherein the camera detecting module 371 may be configured to detect whether a activation event of a camera mode occurs; and

the camera processing module 372 may be configured to, when the activation event of the camera mode is detected, enable a camera mode, and display an image captured by a camera in a background form in a management interface.

FIG. 38 is a block diagram of a device for managing a self-balancing vehicle according to another exemplary embodiment of the present disclosure, which is applied in a user terminal. Based on the device as shown in FIG. 37, the camera processing module 372 may include: an embedding sub-module 381.

Wherein the embedding sub-module 381 may be configured to embed the image captured by the camera below a user interaction layer of the management interface in real time.

FIG. 39 is a block diagram of a device for managing a self-balancing vehicle according to another exemplary embodiment of the present disclosure, which is applied in a user terminal. Based on the device as shown in FIG. 37, the device further may include: a photograph module 391.

Wherein the photograph module 391 may be configured to, under the camera mode, when a activation operation of photographing is detected, enable a camera function to photograph.

FIG. 40 is a block diagram of a device for managing a self-balancing vehicle according to another exemplary embodiment of the present disclosure, which is applied in a user terminal. Based on the device as shown in FIG. 21, the device further may include: a vehicle-searching detecting module 401, a Blue-Tooth pairing module 402 and a vehicle-searching-instruction module 403.

Wherein the vehicle-searching detecting module 401 may be configured to detect whether a vehicle searching operation of a user is received;

the Blue-Tooth pairing module 402 may be configured to, when the vehicle searching operation of the user is received, search for the self-balancing vehicle through Bluetooth, and pair the Bluetooth connection with the self-balancing vehicle; and

the vehicle-searching-instruction module 403 may be configured to, when the Bluetooth connection with the self-balancing vehicle passes the pairing, send a vehicle searching instruction to the self-balancing vehicle such that the self-balancing vehicle performs a vehicle searching warning.

FIG. 41 is a block diagram of a device for managing a self-balancing vehicle according to another exemplary embodiment of the present disclosure, which is applied in a user terminal. Based on the device as shown in FIG. 40, the device further may include: a distance acquiring module 411 and a distance displaying module 412.

Wherein the distance acquiring module 411 may be configured to obtain a distance from the self-balancing vehicle through the Bluetooth connection with the self-balancing vehicle; and

the distance displaying module 412 may be configured to display the distance from the self-balancing vehicle in the management interface.

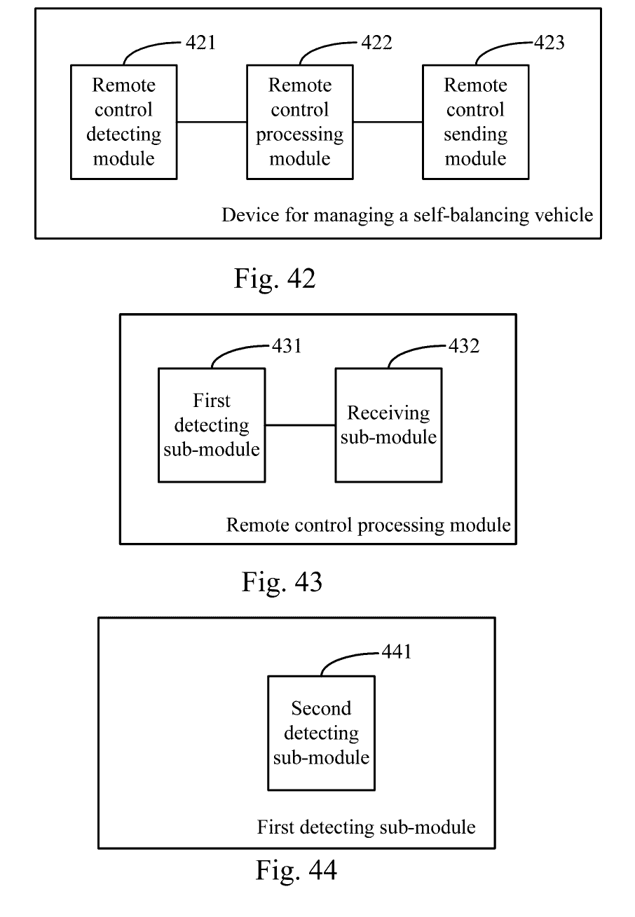

FIG. 42 is a block diagram of a device for managing a self-balancing vehicle according to another exemplary embodiment of the present disclosure, which is applied in a user terminal. Based on the device as shown in FIG. 40, the device further may include: a remote control detecting module 421, a remote control processing module 422 and a remote control sending module 423.

Wherein the remote control detecting module 421 may be configured to detect whether a activation event of remote control navigation occurs;

the remote control processing module 422 may be configured to, when the user terminal detects that the activation event of remote control navigation occurs, enable a navigation remote control function, and receive input information of a navigation direction and navigation speed input from the user; and

the remote control sending module 423 may be configured to send the input information of the navigation direction and navigation speed to the self-balancing vehicle to remotely control travelling of the self-balancing vehicle.

FIG. 43 is a block diagram of a device for managing a self-balancing vehicle according to another exemplary embodiment of the present disclosure, which is applied in a user terminal. Based on the device as shown in FIG. 42, the remote control processing module 422 may include: a first detecting sub-module 431 and a receiving sub-module 432.

Wherein the first detecting sub-module 431 may be configured to enable a navigation remote control function, and detect whether an setting event for the travelling direction and navigation speed of the self-balancing vehicle occurs; and the receiving sub-module 432 may be configured to, when the user terminal detects that the setting event for the travelling direction and navigation speed of the self-balancing vehicle occurs, receive input information of the navigation direction and navigation speed input from the user.

FIG. 44 is a block diagram of a device for managing a self-balancing vehicle according to another exemplary embodiment of the present disclosure, which is applied in a user terminal. Based on the device as shown in FIG. 42, the first detecting sub-module 431 may include: a second detecting sub-module 441.

Wherein the second detecting sub-module 441 may be configured to detect whether an operation event to adjust a directional angle of a dashboard in the management interface and adjust a distance from a center of the dashboard in the management interface occurs.

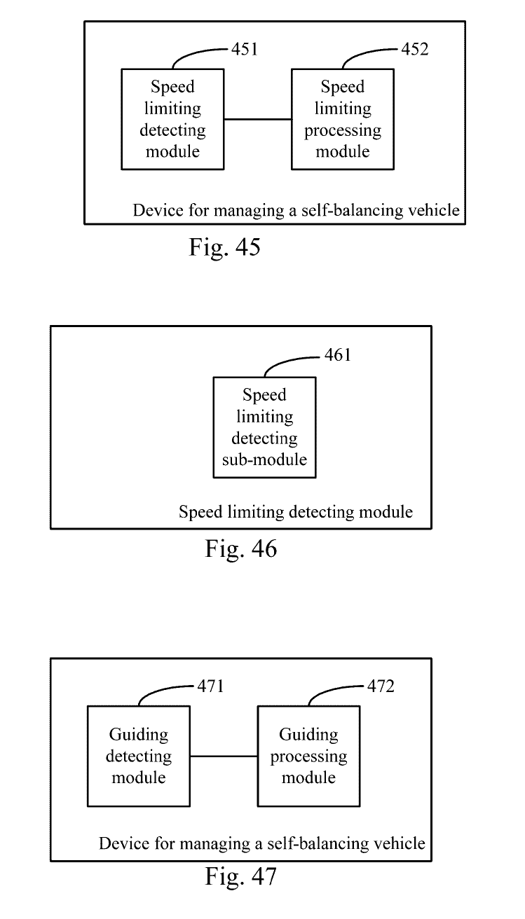

FIG. 45 is a block diagram of a device for managing a self-balancing vehicle according to another exemplary embodiment of the present disclosure, which is applied in a user terminal. Based on the device as shown in FIG. 42, the device further may include: a speed limiting detecting module 451 and a speed limiting processing module 452.

Wherein the speed limiting detecting module 451 may be configured to detect whether a speed limiting operation to the self-balancing vehicle occurs; and

the speed limiting processing module 452 may be configured to, when the user terminal detects the speed limiting operation to the self-balancing vehicle, limit the user to set the navigation speed within a speed limiting scope.

FIG. 46 is a block diagram of a device for managing a self-balancing vehicle according to another exemplary embodiment of the present disclosure, which is applied in a user terminal. Based on the device as shown in FIG. 45, the speed limiting detecting module 451 may include: a speed limiting detecting sub-module 461.

Wherein the speed limiting detecting sub-module 461 may be configured to detect whether a setting of highest navigation speed for a speed-controlling bar in a remote control navigation interface occurs.

FIG. 47 is a block diagram of a device for managing a self-balancing vehicle according to another exemplary embodiment of the present disclosure, which is applied in a user terminal. Based on the device as shown in FIG. 21, the device further may include: a guiding detecting module 471 and a guiding processing module 472.

Wherein the guiding detecting module 471 may be configured to detect whether a activation operation of guiding from the user is received; and

the guiding processing module 472 may be configured to, if the activation operation of guiding is received, call a map function to acquire and display guiding information in real time.

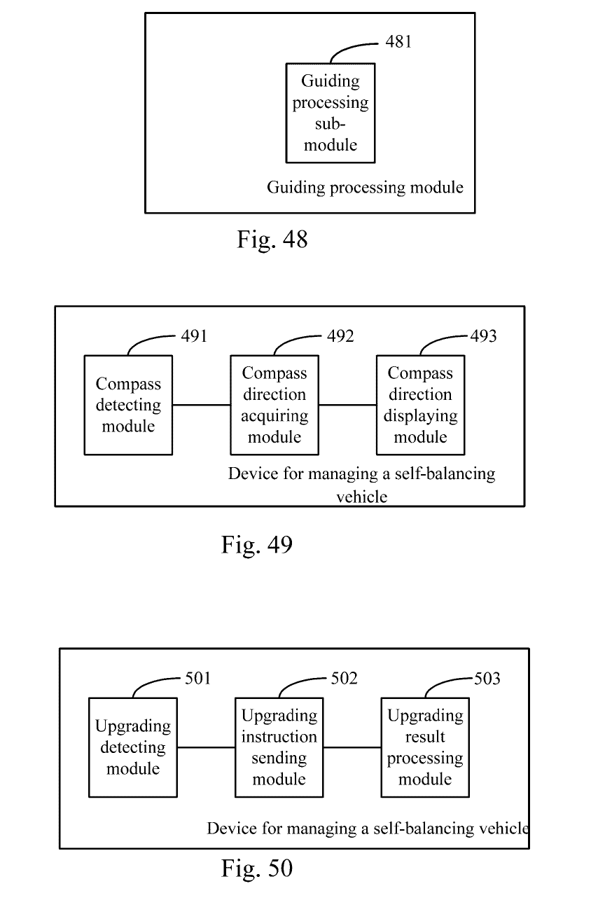

FIG. 48 is a block diagram of a device for managing a self-balancing vehicle according to another exemplary embodiment of the present disclosure, which is applied in a user terminal. Based on the device as shown in FIG. 47, the guiding processing module 472 may include: a guiding processing sub-module 481.

Wherein the guiding processing sub-module 481 may be configured to enable the map function, and switch to a guiding interface to acquire and display a current location and guiding direction data in real time.

FIG. 49 is a block diagram of a device for managing a self-balancing vehicle according to another exemplary embodiment of the present disclosure, which is applied in a user terminal. Based on the device as shown in FIG. 21, the device further may include: a compass detecting module 491, a compass direction acquiring module 492 and a compass direction displaying module 493.

Wherein the compass detecting module 491 may be configured to detect whether an operation of activate a compass from a user is received;

the compass direction acquiring module 492 may be configured to, if the activation operation of the compass is received, acquire a direction indicated by the compass of a system; and

the compass direction displaying module 493 may be configured to display the direction indicated by the compass of the system in the management interface in real time.

FIG. 50 is a block diagram of a device for managing a self-balancing vehicle according to another exemplary embodiment of the present disclosure, which is applied in a user terminal. Based on the device as shown in FIG. 21, the device further may include: an upgrading detecting module 501, an upgrading instruction sending module 502 and an upgrading result processing module 503.

Wherein the upgrading detecting module 501 may be configured to detect whether a activation operation of remote upgrading from the user is received;

the upgrading instruction sending module 502 may be configured to, if the activation operation of remote upgrading from the user is received, send an upgrading instruction to the self-balancing vehicle through the connection; and

the upgrading result processing module 503 may be configured to, receive an upgrading result returned by the self-balancing vehicle, and display the upgrading result in the management interface.

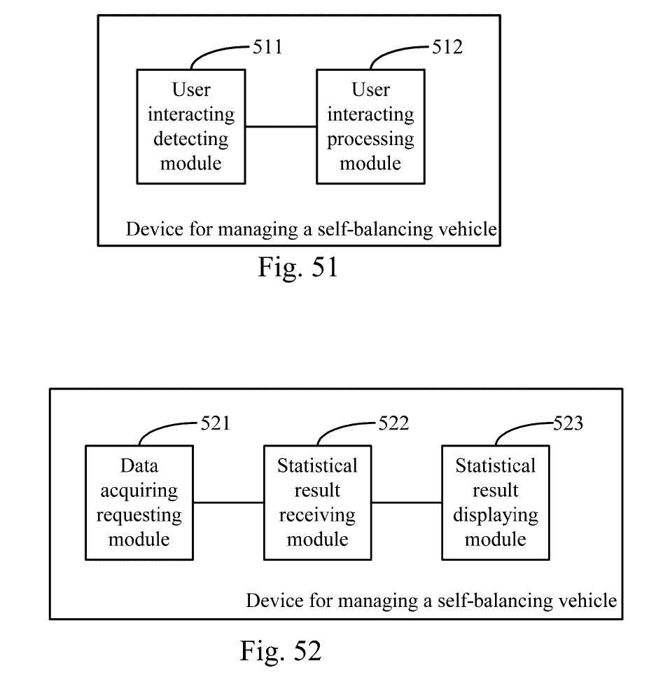

FIG. 51 is a block diagram of a device for managing a self-balancing vehicle according to another exemplary embodiment of the present disclosure, which is applied in a user terminal. Based on the device as shown in FIG. 21, the device further may include: a user interaction detecting module 511 and a user interaction processing module 512.

Wherein the user interaction detecting module 511 may be configured to detect whether a activation operation of user interaction occurs; and

the user interaction processing module 512 may be configured to, if the user terminal detects that the activation operation of user interaction occurs, establish a connection with a server to send or receive interacting information.

FIG. 52 is a block diagram of a device for managing a self-balancing vehicle according to another exemplary embodiment of the present disclosure, which is applied in a user terminal. Based on the device as shown in FIG. 21, the device further may include: a data acquiring requesting module 521, a statistical result receiving module 522 and a statistical result displaying module 523.

Wherein the data acquiring requesting module 521 may be configured to send to a server a request for users of a plurality of self-balancing vehicles to acquire network data;

the statistical result receiving module 522 may be configured to receive a statistical result obtained by the server according to the acquiring request; and

the statistical result displaying module 523 may be configured to display and analyze the statistical result.

Corresponding to FIG. 21, the present disclosure further may provide another device for managing a self-balancing vehicle, including:

a processor; and

a memory for storing instructions executable by the processor,

wherein the processor may be configured to perform:

establishing a connection with the self-balancing vehicle through Bluetooth;

acquiring status information of the self-balancing vehicle through the connection; and

managing the self-balancing vehicle according to the status information of the self-balancing vehicle.

Implementation of the functions and operations of the modules in the above devices may be specifically referred to the implementation of the corresponding steps in the above methods, which may not be repeated herein.

For the device embodiments, since they correspond to the method embodiments, they may be referred to the related part of the description of the method embodiments. The device embodiments described above are merely illustrative. The units described as separate may be or may not be physically separate, and the components illustrated as a units may be or may not be physical units, and may be at the same location, or may be distributed to multiple units over the network. A part of or all of the modules may be selected to achieve the objective of the present disclosure as desired. One skilled in the art can understand and practice the embodiments without paying creative labor.

A non-transitory computer readable storage medium, when instructions in the storage medium are executed by a processor of a mobile terminal, the mobile terminal is caused to perform the method for managing a self-balancing vehicle. The method may include:

establishing a connection with the self-balancing vehicle through Bluetooth;

acquiring status information of the self-balancing vehicle through the connection; and

managing the self-balancing vehicle according to the status information of the self-balancing vehicle.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure present disclosure is not limited to the exact construction that has been described above and illustrated in the accompanying drawings, and that various modifications and changes can be made without departing from the scope thereof. It is intended that the scope of the present disclosure only be limited by the appended claims.

1. A method for managing a self-balancing vehicle through a mobile terminal, comprising:
establishing, by the mobile terminal, a wireless connection with the self-balancing vehicle;
obtaining, by the mobile terminal, status information of the self-balancing vehicle through the wireless connection; and
conducting, by the mobile terminal, a predetermine operation to the self-balancing vehicle according to the status information of the self-balancing vehicle.

2. The method of claim 1, further comprising:
detecting, by the mobile terminal, whether a speed-adjusting event occurs; and
when the speed-adjusting event occurs, sending, by the mobile terminal, a speed adjusting value to the self-balance vehicle through the wireless connection.

3. The method of claim 1, wherein predetermined operation to the self-balancing vehicle further comprises:
monitoring the status information; and
activating a notification when the status information reflects a predetermined navigation state threshold.

4. The method of claim 1, further comprising:
determining, by the mobile terminal, whether the self-balancing vehicle is in a locked state; and
when the self-balancing vehicle is in the locked state, releasing, by the mobile terminal, the locked state of the self-balancing vehicle.

5. The method of claim 1, further comprising:
detecting, by the mobile terminal, whether a activation event of a camera mode occurs; and
when the activation event of the camera mode occurs, instructing, by the mobile terminal, the self-balancing vehicle to activate a camera on the self-balancing vehicle, and displaying, by the mobile terminal, an image captured by the camera as a background of a management interface of the mobile terminal.

6. The method of claim 5, wherein the displaying of an image captured by the camera comprises:
embedding the image captured by the camera below a user interaction layer of the management interface in real time.

7. The method of claim 5, wherein the status information comprises information of at least one of remaining battery power or remaining cruising mileage of the self-balancing vehicle; and
the method further comprising displaying, by the mobile terminal, the status information on the management interface of the mobile terminal.

8. The method of claim 1, further comprising:
receiving, by the mobile terminal, a vehicle searching instruction from a user;
searching, by the mobile terminal, a self-balancing vehicle in a communication range of the mobile terminal;
establishing, by the mobile terminal, a wireless connection with the self-balancing vehicle; and
when the wireless connection is established with the self-balancing vehicle, sending, by the mobile terminal, a vehicle searching instruction to the self-balancing vehicle to render the self-balancing vehicle performs a vehicle searching warning.

9. The method of claim 8, wherein the searching for the self-balancing vehicle and the pairing of the wireless connection with the self-balancing vehicle further comprises:
obtaining a distance between the self-balancing vehicle and the mobile terminal through the wireless connection; and
displaying the distance from the self-balancing vehicle in a management interface on the mobile terminal.

10. The method of claim 8, further comprising, detecting, by the mobile terminal, whether a activation event of remote control navigation occurs, enabling, by the mobile terminal, a remote control navigation function;
receiving, by the mobile terminal, input information of a navigation direction and navigation speed input; and
sending, by the mobile terminal, the input information of the navigation direction and navigation speed to the self-balancing vehicle to remotely control navigation of the self-balancing vehicle.

11. The method of claim 10, further comprising:
receiving, by the mobile terminal, an instruction from the user to adjust the self-balancing vehicle to a target speed; and
instructing, by the mobile terminal, the self-balancing vehicle to adjust to the target speed but not higher than a predetermined speed limit.

12. The method of claim 1, further comprising:
receiving, by the mobile terminal, a activation operation of guiding from a user; and
calling, by the mobile terminal, a map function to acquire and display guiding information in real time.

13. The method of claim 1, further comprising:
receiving, by the mobile terminal, an operation to activate a compass;
acquiring, by the mobile terminal, a direction indicated by the compass of a system; and
displaying, by the mobile terminal, the direction indicated by the compass of the system in the management interface in real time.

14. The method of claim 1, further comprising:
receiving, by the mobile terminal, an activation operation to allow user interaction; and
establishing, by the mobile terminal, a connection with a server to send or receive interacting information.

15. The method of claim 1, further comprising:
sending, by the mobile terminal, usage data of a plurality of self-balancing vehicles to a server,
receiving, by the mobile terminal, from the server a statistical result of usage information of the plurality of self-balancing vehicles, wherein the plurality of self-balancing vehicle includes the self-balancing vehicle; and
displaying, by the mobile terminal, and analyzing the statistical result.

16. A mobile terminal, comprising:
a memory having a set of instructions for managing a self-balancing vehicle; and
a processor in communication with the memory, wherein the processor is configured by the set of instructions to:
establish a wireless connection with a self-balancing vehicle;
acquire status information of the self-balancing vehicle through the wireless connection; and
conducting a predetermined operation to the self-balancing vehicle according to the status information of the self-balancing vehicle.

17. The mobile terminal of claim 16, wherein the processor is further configured to:
detect whether a speed-adjusting event occurs; and
when the mobile terminal detects that the speed-adjusting event occurs, send a speed adjusting value to the self-balance vehicle through the wireless connection.

18. The mobile terminal of claim 16, wherein the processor is further configured to:
display the status information in a management interface; and
monitor the status information, and alarm a user of the mobile terminal when the status information reaches a corresponding navigation state threshold.

19. The mobile terminal of claim 16, wherein the processor is further configured to:
determine whether the self-balancing vehicle is in a locked state; and
when self-balancing vehicle is determined that the self-balancing vehicle is in the locked state, instruct the self-balancing vehicle to release the locked state.

20. The mobile terminal of claim 16, wherein the processor is further configured to:
determine whether a activation event of a camera mode occurs; and
when the activation event of the camera mode is detected, instruct the self-balancing vehicle to activate a camera therein, and display an image captured by the camera as a background of a management interface display on the mobile terminal.
